(19) United States
(12) Patent Application Publication
(10) Pub. No.: US 2022/0335434 A1
(43) Pub. Date: Oct. 20, 2022

(54) INFORMATION PROCESSING DEVICE, SETTLEMENT PROCESSING SYSTEM, METHOD, AND PROGRAM

(71) Applicant: FELICA NETWORKS, INC., TOKYO (JP)

(72) Inventors: Yasamasa NAKATSUGAWA, TOKYO (JP); Atsuo YONEDA, TOKYO (JP); Takashi SUZUKI, TOKYO (JP)

(21) Appl. No.: 17/636,547

(22) PCT Filed: Jul. 20, 2020
(86) PCT No.: PCT/JP2020/028146

§ 371 Date: Feb. 18, 2022

(30) Foreign Application Priority Data
Aug. 29, 2019 (JP) 2019-157148

(51) Int. Cl. G06Q 20/40; G06Q 20/32; G10L 25/51

(52) U.S. Cl. CPC G06Q 20/40145; G06Q 20/32; G10L 25/51

(57) ABSTRACT

Provided is a configuration that confirms a settlement means designated by a user who makes settlement and reliably makes the settlement involving communication with a user terminal of the user. A store terminal inputs a user utterance made by the user and designating the settlement means via a microphone, executes voice recognition processing to determine the settlement means designated by the user, and transmits the user utterance to the user terminal via a communication unit. The user terminal determines whether or not the user utterance input from the store terminal matches a registered user utterance for collation stored in a storage unit, and transmits a payment execution notification to the store terminal on the basis of determination that the user utterance matches the registered user utterance. The store terminal executes the settlement processing in response to the payment execution notification received from the user terminal.

### TECHNICAL FIELD

The present disclosure relates to an information processing device, a settlement processing system, a method, and a program. More specifically, the present disclosure relates to an information processing device, a settlement processing system, a method, and a program that enable secure settlement processing.

### BACKGROUND ART

In recent years, a cashless settlement processing system has rapidly spread and evolved, and a system has been used that enables settlement processing by performing communication between a user terminal such as a smartphone (smartphone) owned by a user and a store terminal (cash register) installed in a store.

Currently, many systems are being used in which a user brings a user terminal such as a smartphone put in a pocket or a bag into contact with or close to a store terminal in a store, so that the user terminal and the store terminal perform short-range wireless communication to perform settlement processing.

Furthermore, a system is also currently being developed in which a user terminal such as a smartphone and a store terminal perform short-range wireless communication at a timing when a user passes by the store terminal without the user taking out the user terminal put in a pocket or a bag and perform settlement processing, and it is predicted that the system will be widely used in the future.

Such a settlement processing system is called a tapless settlement system.

However, there are a wide variety of settlement means using the tapless settlement system. That is, there are many settlement means such as various types of electronic money, code settlement using a QR code (registered trademark), a bar code, or the like, such as xx pay, a credit card, and a settlement bank account. The settlement means to be used differs depending on the user who makes payment.

Therefore, the store terminal needs to confirm which settlement means the user uses to make settlement.

Furthermore, in a case where the settlement processing using the tapless settlement system is performed, the store terminal needs to clearly distinguish between the user terminal owned by the user who performs the settlement processing and another user terminal of another user near the user.

In a case where the distinguishing processing is incomplete, there is a possibility that an error may occur in which the store terminal communicates with the another user terminal that does not need to perform the settlement processing and makes settlement from a settlement account of the another user.

As described above, in order to make tapless settlement, it is necessary to reliably perform confirmation processing of the settlement means for the user and discrimination processing between the user terminal that performs the settlement processing and another user terminal.

Regarding how to perform these types of processing, there are currently no effective specific measures.

Note that, for example, Patent Document 1 (Japanese Patent Application Laid-Open No. 2008-204151) discloses a configuration in which, in a case where a user having a terminal capable of using a plurality of settlement means selects and uses one settlement means in a certain store, the selected settlement means is automatically selected thereafter.

However, this document does not particularly describe a configuration for processing such as identity confirmation, and there is a problem that measures against errors and unauthorized use at the time of settlement are insufficient.

Furthermore, for example, Patent Document 2 (Japanese Patent Application Laid-Open No. 2010-033143) as a conventional technology discloses a configuration in which a face image of a user is captured by a camera attached to a store terminal (POS), and user information obtained from the captured image is recorded in a database (DB) in association with a sales history.

This document discloses a configuration in which the captured image of the user is used to analyze purchased product information according to a user attribute. This document does not disclose a configuration in which the captured image of the user is used to prevent an error at the time of tapless settlement.

### CITATION LIST

### Patent Document

Patent Document 1: Japanese Patent Application Laid-Open No. 2008-204151
Patent Document 2: Japanese Patent Application Laid-Open No. 2010-033143

### SUMMARY OF THE INVENTION

### Problems to be Solved by the Invention

The present disclosure has been made in view of the above-described problems, for example, and an object thereof is to provide an information processing device, a settlement processing system, a method, and a program capable of reliably making so-called tapless settlement, which is a system in which a user performs short-range wireless communication with a store terminal without taking out a user terminal such as a smartphone put in a pocket or a bag and performs settlement processing.

An embodiment of the present disclosure provides an information processing device, a settlement processing system, a method, and a program that confirm a settlement means to be used by a user and make tapless settlement by applying the confirmed settlement means.

Furthermore, an embodiment of the present disclosure provides an information processing device, a settlement processing system, a method, and a program that clearly distinguish a user or a user terminal to make settlement from another user or user terminal and then make the tapless settlement without an error.

### Solutions to Problems

A first aspect of the present disclosure lies in

an information processing device including:

a communication unit; and

a data processing unit, in which

the data processing unit

inputs a user utterance made by a user and designating a settlement means from a store terminal via the communication unit,

determines whether or not the user utterance input from the store terminal matches a registered user utterance for collation stored in a storage unit, and

communicates with the store terminal to perform settlement processing in response to determination that the user utterance matches the registered user utterance.

Moreover, a second aspect of the present disclosure lies in

an information processing device including:

a microphone;

a communication unit that communicates with a user terminal; and

a data processing unit, in which

the data processing unit

inputs a user utterance made by a user and designating a settlement means via the microphone, executes voice recognition processing to determine the settlement means designated by the user,

transmits the user utterance to the user terminal via the communication unit, and

executes settlement processing in response to a payment execution notification received from the user terminal when authentication based on the user utterance is established in the user terminal.

Moreover, a third aspect of the present disclosure lies in

a settlement processing system including: a user terminal; and a store terminal, in which

the store terminal

inputs a user utterance made by a user and designating a settlement means via a microphone, executes voice recognition processing to determine the settlement means designated by the user, and

transmits the user utterance to the user terminal via the communication unit,

the user terminal

determines whether or not the user utterance input from the store terminal matches a registered user utterance for collation stored in a storage unit, and

transmits a payment execution notification to the store terminal in response to determination that the user utterance matches the registered user utterance, and

the store terminal

executes settlement processing in response to the payment execution notification received from the user terminal.

Moreover, a fourth aspect of the present disclosure lies in

an information processing method executed by a data processing unit of an information processing device, the information processing method including:

inputting a user utterance made by a user and designating a settlement means from a store terminal via the communication unit;

determining whether or not the user utterance input from the store terminal matches a registered user utterance for collation stored in a storage unit; and

communicating with the store terminal to perform settlement processing in response to determination that the user utterance matches the registered user utterance.

Moreover, a fifth aspect of the present disclosure lies in

an information processing method executed by a data processing unit of an information processing device, the information processing method including:

inputting a user utterance made by a user and designating a settlement means via a microphone, executing voice recognition processing to determine the settlement means designated by the user;

transmitting the user utterance to the user terminal via a communication unit; and

executing settlement processing in response to a payment execution notification received from the user terminal when authentication based on the user utterance is established in the user terminal.

Moreover, a sixth aspect of the present disclosure lies in

a program for causing a data processing unit of an information processing device to execute information processing including:

inputting a user utterance made by a user and designating a settlement means from a store terminal via the communication unit;

determining whether or not the user utterance input from the store terminal matches a registered user utterance for collation stored in a storage unit; and

communicating with the store terminal to perform settlement processing in response to determination that the user utterance matches the registered user utterance.

Moreover, a seventh aspect of the present disclosure lies in

a program for causing a data processing unit of an information processing device to execute information processing including:

inputting a user utterance made by a user and designating a settlement means via a microphone, executing voice recognition processing to determine the settlement means designated by the user;

transmitting the user utterance to the user terminal via a communication unit; and

executing settlement processing in response to a payment execution notification received from the user terminal when authentication based on the user utterance is established in the user terminal.

Note that each of the programs of the present disclosure is, for example, a program that can be provided by a storage medium or a communication medium provided in a computer-readable format for an information processing device or a computer system capable of executing various program codes. Such a program is provided in a computer-readable format, so that processing according to the program is implemented on the information processing device or the computer system.

Still other objects, characteristics, and advantages of the present disclosure will become apparent from more detailed description based on embodiments of the present disclosure described later and the accompanying drawings. Note that, in the present specification, a system is a logically assembled configuration of a plurality of devices, and is not limited to a system in which devices having respective configurations are in the same housing.

According to a configuration of an embodiment of the present disclosure, a configuration is implemented in which a settlement means designated by a user who makes settlement is confirmed, and the settlement involving communication with a user terminal of the user is reliably made.

Specifically, for example, a store terminal inputs, via a microphone, a user utterance made by the user and designating the settlement means, executes voice recognition processing to determine the settlement means designated by the user, and transmits the user utterance to the user terminal via a communication unit. The user terminal determines whether or not the user utterance input from the store terminal matches a registered user utterance for collation stored in a storage unit, and transmits a payment execution notification to the store terminal on the basis of determination that the user utterance matches the registered user utterance. The store terminal executes the settlement processing in response to the payment execution notification received from the user terminal.

With this configuration, a configuration is implemented in which a settlement means designated by a user who makes settlement is confirmed, and the settlement involving communication with a user terminal of the user is reliably made.

Note that the effects described in the present specification are merely examples and are not limited, and additional effects may be provided.

### BRIEF DESCRIPTION OF DRAWINGS

FIG. 1 is a diagram for describing an outline and problems of tapless settlement.

FIG. 2 is a diagram for describing exemplary processing executed by a store terminal as an example of an information processing device of the present disclosure.

FIG. 3 is a diagram for describing an example of a processing sequence in which a user preregisters a user utterance regarding a settlement means in a user terminal.

FIG. 4 is a diagram for describing an example of a sequence of settlement processing.

FIG. 5 is a diagram for describing the example of the sequence of the settlement processing.

FIG. 6 is a diagram for describing a specific example of display data for user intention confirmation.

FIG. 7 is a diagram for describing an example of display data of a settlement completion notification.

FIG. 8 is a diagram for describing an example of a sequence of the settlement processing.

FIG. 9 is a diagram for describing an example of display data for displaying notification data indicating that identity confirmation processing based on user utterance collation processing has failed and for confirming an intention of the user to make payment.

FIG. 10 is a diagram for describing an example of a sequence of settlement processing.

FIG. 11 is a diagram for describing an example of a sequence of the settlement processing.

FIG. 12 is a diagram for describing the example of the sequence of the settlement processing.

FIG. 13 is a diagram for describing the example of the sequence of the settlement processing.

FIG. 14 is a diagram for describing an example of a sequence of the settlement processing.

FIG. 15 is a diagram for describing the example of the sequence of the settlement processing.

FIG. 16 is a diagram for describing a payer entry area identification mark.

FIG. 17 is a diagram for describing an example of a sequence of settlement processing.

FIG. 18 is a diagram for describing the example of the sequence of the settlement processing.

FIG. 19 is a diagram for describing an example of a sequence of settlement processing and display data on a user terminal.

FIG. 20 is a diagram for describing an example of a sequence of the settlement processing.

FIG. 21 is a diagram for describing the example of the sequence of the settlement processing.

FIG. 22 is a diagram for describing an example of a sequence of settlement processing and display data on a user terminal.

FIG. 23 is a diagram for describing an example of a sequence of the settlement processing.

FIG. 24 is a diagram for describing the example of the sequence of the settlement processing.

FIG. 25 is a diagram for describing an example of a sequence of settlement processing.

FIG. 26 is a diagram for describing an example of a sequence of the settlement processing.

FIG. 27 is a diagram for describing the example of the sequence of the settlement processing.

FIG. 28 is a diagram for describing an embodiment in which a user terminal to make settlement is specified by use of camera-captured images and communication information of short-range wireless communication units.

FIG. 29 is a diagram for describing an example of user attribute/user terminal correspondence data.

FIG. 30 is a diagram for describing the embodiment in which the user terminal to make settlement is specified by use of the camera-captured images and the communication information of the short-range wireless communication units.

FIG. 31 is a diagram for describing an example of the user attribute/user terminal correspondence data.

FIG. 32 is a diagram for describing the embodiment in which the user terminal to make settlement is specified by use of the camera-captured images and the communication information of the short-range wireless communication units.

FIG. 33 is a diagram for describing an example of the user attribute/user terminal correspondence data.

FIG. 34 is a diagram for describing the embodiment in which the user terminal to make settlement is specified by use of the camera-captured images and the communication information of the short-range wireless communication units.

FIG. 35 is a diagram for describing an example of the user attribute/user terminal correspondence data.

FIG. 36 is a diagram for describing an embodiment in which a user terminal is specified by use of camera-captured images and communication information of short-range wireless communication units to perform gate control.

FIG. 37 is a diagram for describing the embodiment in which the user terminal is specified by use of the camera-captured images and the communication information of the short-range wireless communication units to perform gate control.

FIG. 38 is a diagram for describing the embodiment in which the user terminal is specified by use of the camera-captured images and the communication information of the short-range wireless communication units to perform gate control.

FIG. 39 is a flowchart for describing a sequence of processing of specifying the user terminal by use of the camera-captured images and the communication information of the short-range wireless communication units to perform gate control.

FIG. 40 is a diagram for describing a configuration example of a user terminal used for processing of the present disclosure.

FIG. 41 is a diagram for describing a configuration example of a store terminal used for processing of the present disclosure.

FIG. 42 is a diagram for describing a hardware configuration example of the user terminal, the store terminal, and a server used for processing of the present disclosure.

### MODE FOR CARRYING OUT THE INVENTION

Hereinafter, details of an information processing device, a settlement processing system, a method, and a program of the present disclosure will be described with reference to the drawings. Note that the description will be made according to the following items.

1. Outline and problems of tapless settlement system

2. (First Embodiment) Embodiment in which settlement means to be used by user is confirmed

3. (Second Embodiment) Embodiment in which store terminal selects terminal to make settlement from plurality of user terminals

4. (Third Embodiment) Embodiment in which settlement processing is performed in unattended store without store clerk

5. (Fourth embodiment) Embodiment in which user performs settlement processing by making utterance about settlement means to be used toward user terminal instead of store terminal

6. (Fifth embodiment) Embodiment in which piece of utterance data selected by user from plurality of pieces of utterance data preregistered in user terminal and designating settlement means to be used is transmitted to store terminal to perform settlement processing

7. (Sixth embodiment) Embodiment in which face authentication based on captured image of user is executed

8. (Seventh embodiment) Embodiment in which user or user terminal that makes settlement is specified on the basis of captured images of user (customer) moving in store and information received from user terminal

9. Configuration example of each device

10. Summary of configuration of present disclosure

### 1. Outline and Problems of Tapless Settlement System

First, an outline and problems of a tapless settlement system will be described.

As described above, the so-called tapless settlement system is being developed, that is, a system is being developed in which a user terminal such as a smartphone and a store terminal perform short-range wireless communication at a timing when a user passes by the store terminal without the user taking out the user terminal put in a pocket or a bag and perform settlement processing, and it is predicted that the system will be widely used in the future.

However, there are a wide variety of settlement means using the tapless settlement system. That is, there are many settlement means such as various types of electronic money, code settlement using a QR code (registered trademark), a bar code, or the like, such as xx pay, a credit card, and a settlement bank account. The settlement means to be used differs depending on the user who makes payment.

Therefore, the store terminal needs to confirm which settlement means the user uses to make settlement.

Furthermore, in a case where the settlement processing using the tapless settlement system is performed, the store terminal needs to clearly distinguish between the user terminal owned by the user who performs the settlement processing and another user terminal of another user near the user.

In a case where the distinguishing processing is incomplete, there is a possibility that an error may occur in which the store terminal communicates with the another user terminal that does not need to perform the settlement processing and makes settlement from a settlement account of the another user.

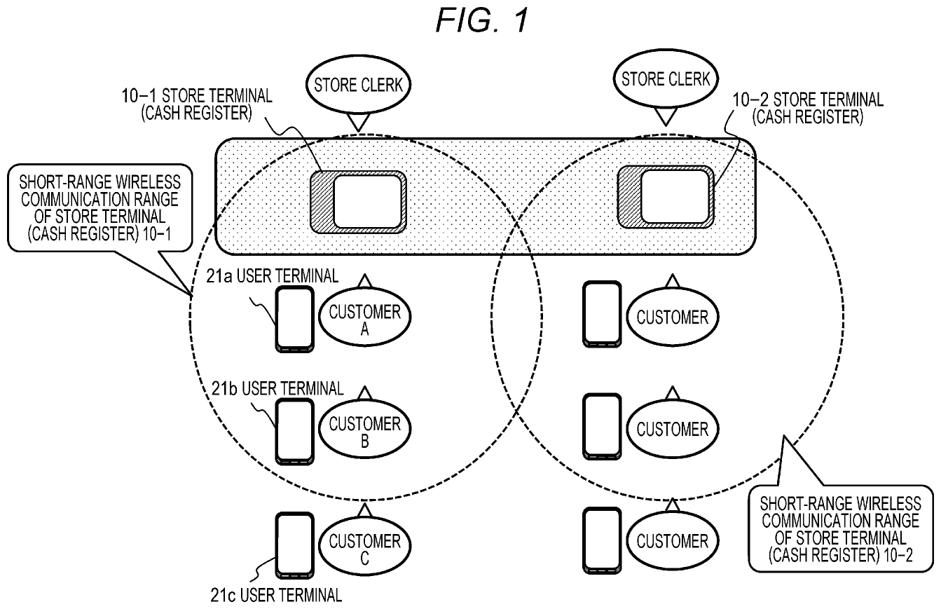

A specific example of the problems in the tapless settlement will be described with reference to FIG. 1. FIG. 1 illustrates a state in which each of store terminals (cash registers) 10 is placed in front of one of two store clerks of a store, and customers who pay for items are each waiting in line in front of one of the store terminals (cash registers) 10.

Each customer holds a user terminal 21 in a pocket or a bag.

In the case of making tapless settlement, it is necessary for the store terminal (cash register) 10 and the user terminal of the person to make the payment (=person to make the settlement) to communicate with each other.

In the example illustrated in FIG. 1, a store terminal (cash register) 10-1 on the left side of FIG. 1 first communicates with a user terminal 21a of a customer A at the head to perform settlement processing. In this case, the store terminal 10-1 needs to confirm which settlement means the user A intends to use to make the settlement on the user terminal 21a.

That is, it is necessary to confirm which settlement means is used to make the settlement from among many settlement means such as various types of electronic money, code settlement using a QR code (registered trademark), a bar code, or the like, such as xx pay, a credit card, and a settlement bank account.

Furthermore, the short-range wireless communication range of the store terminal (cash register) 10-1 on the left side of FIG. 1 is within a dotted circle around the store terminal (cash register) 10-1 on the left side illustrated in FIG. 1.

The dotted circle includes the user terminal 21a of the customer A and a user terminal 21b of a customer B.

In this case, the store terminal (cash register) 10-1 can communicate (perform short-range wireless communication) with both the user terminal 21a of the customer A and the user terminal 21b of the customer B.

Therefore, it is necessary for the store terminal (cash register) 10-1 to determine which of the user terminal 21a of the customer A and the user terminal 21b of the customer B is the terminal to perform the settlement processing.

As described above, the tapless settlement has the following problems:

(a) how to perform confirmation processing of the settlement means for the user; and

(b) how to discriminate between the user terminal to perform the settlement processing and another user terminal.

These are the problems.

The present disclosure solves these problems.

Hereinafter, configurations and processing of the present disclosure will be described.

### 2. (First Embodiment) Embodiment in which Settlement Means to be Used by User is Confirmed

First, as a first embodiment, an embodiment will be described in which a settlement means to be used by a user is confirmed.

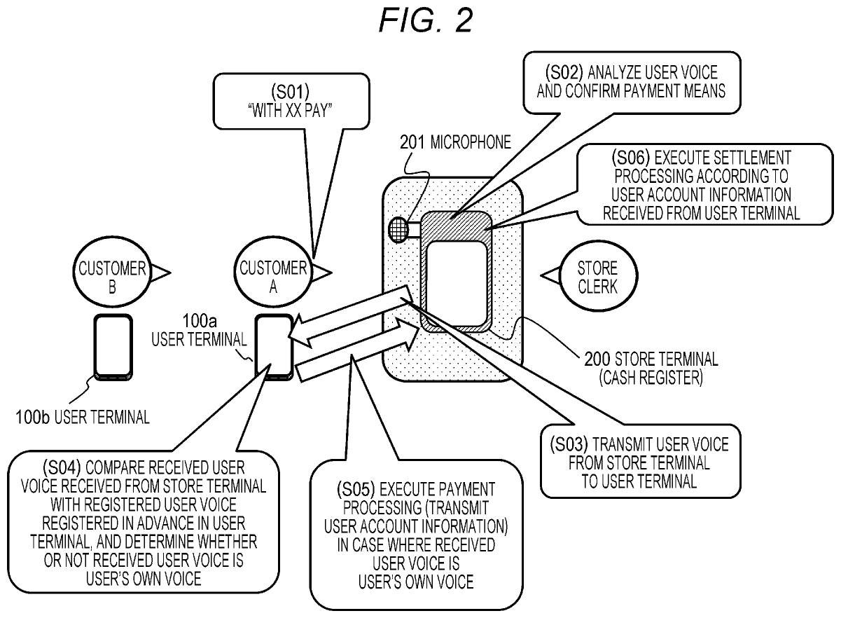

FIG. 2 is a diagram for describing exemplary processing executed by a store terminal 200 as an example of an information processing device of the present disclosure.

The store terminal (cash register) 200 includes a microphone 201.

In FIG. 2, the store terminal 200 is placed in front of a store clerk, and a customer A as a user who intends to make tapless settlement stands in front of the store terminal 200.

The customer A holds a user terminal 100a such as a smartphone.

Short-range wireless communication is performed between the store terminal 200 and the user terminal 100a, and settlement processing is executed.

Note that the short-range wireless communication executed between the store terminal 200 and the user terminal 100a is, for example, short-range wireless communication such as Bluetooth (registered trademark) (BT) communication, near field communication (NFC) communication, radio frequency (RF) communication, or ultra wide band (UWB) communication.

The settlement processing by the store terminal 200 of the present disclosure is performed in the order of steps S01 to S06 illustrated in FIG. 2. Hereinafter, processing of each step will be described.

(Step S01)

First, the customer A utters a settlement means.

As an example, it is assumed that the customer A utters “with XX pay”.

(Step S02)

The store terminal 200 inputs the utterance of the customer A “with XX pay” via the microphone 201, and in step S02, a data processing unit in the store terminal 200 executes voice analysis of the input utterance and determines that the user who intends to perform the settlement processing, that is, the customer A wants to use [XX pay] as the settlement means.

(Step S03)

Next, in step S03, the store terminal 200 transmits the utterance voice of the customer A “with XX pay” to the user terminal 100a by using short-range wireless communication.

(Step S04)

Next, in step S04, the user terminal 100a compares the received user voice received from the store terminal 200 with a registered user voice registered in advance in the user terminal 100a, and determines whether or not the received user voice is the user's own voice.

Note that, in the user terminal 100a, an utterance voice of the customer A “with XX pay” is registered in advance. This utterance voice is registered in advance by the user as voice data for collation.

Details of this processing will be described later.

In a case where, in step S04, the user terminal 100a confirms that the received user voice received from the store terminal 200 matches the registered user voice registered in advance in the user terminal 100a, it is determined that the user voice received from the store terminal 200 is the user's own voice.

In this case, processing in and after step S05 is executed.

In a case where the matching is not confirmed, an error notification is sent from the user terminal 100a to the store terminal 200, and the processing in and after step S05 is not executed.

(Step S05)

In the case where, in step S04, the user terminal 100a confirms that the received user voice received from the store terminal 200 matches the registered user voice registered in advance in the user terminal 100a, it is determined that the user voice received from the store terminal 200 is the user's own voice, and the processing in and after step S05 is executed.

In this case, the user terminal 100a executes payment processing in step S05. Specifically, account information or the like of the user (customer A) necessary for the settlement processing is transmitted to the store terminal 200.

Note that the transmitted information is different information depending on the settlement means to be used by the user (customer A).

(Step S06)

Next, in step S06, the store terminal 200 executes the settlement processing according to the user account information received from the user terminal 100a.

Through the series of processing, the store terminal 200 can confirm the settlement means to be used by the user (customer A) and perform the settlement processing to which the confirmed settlement means is applied.

Note that, as understood from the above description, in the present embodiment, the user utterance designating the settlement means, which is made in step S01, is fed back and input from the store terminal 200 to the user terminal 100a, and the collation processing between the input utterance and the registered user utterance registered in advance in the user terminal 100a is executed.

In a case where, in this collation processing, it is confirmed that the input utterance matches the registered utterance, the subsequent settlement processing is performed.

This processing is performed so that confirmation of the settlement means of the user (customer A) who executes the settlement processing is reliably executed.

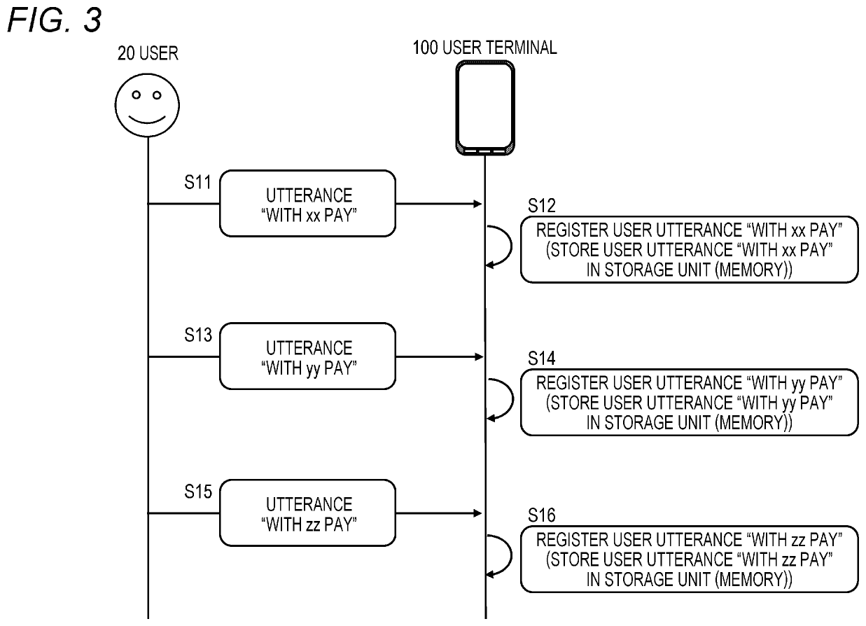

Next, processing sequences of the first embodiment will be described with reference to FIG. 3 and the subsequent drawings.

First, a processing sequence in which a user 20 preregisters a user utterance regarding a settlement means in a user terminal 100 will be described with reference to FIG. 3.

This is processing in which the utterance regarding the settlement means to be used by the user 20 for settlement processing (payment processing) is preregistered in the user terminal 100. That is, the processing is preregistration processing of collation data.

The collation data is recorded in a storage unit of the user terminal 100.

FIG. 3 illustrates the user 20 on the left side and the user terminal 100 owned by the user 20 on the right side.

In S11, the user 20 makes a user utterance “with xx pay”, which is an utterance designating a settlement means, toward the user terminal 100.

In step S12, the user terminal 100 inputs the user utterance “with xx pay” via a microphone and stores the user utterance in the storage unit (memory). That is, the user utterance is registered as the collation data.

Furthermore, in S13, the user 20 makes a user utterance “with yy pay”, which is another utterance designating a settlement first stage, toward the user terminal 100.

In step S14, the user terminal 100 inputs the user utterance “with yy pay” via the microphone and stores the user utterance in the storage unit (memory). That is, the user utterance is registered as the collation data.

Furthermore, in S15, the user 20 makes a user utterance “with zz pay”, which is another utterance designating a settlement first stage, toward the user terminal 100.

In step S16, the user terminal 100 inputs the user utterance “with zz pay” via the microphone and stores the user utterance in the storage unit (memory). That is, the user utterance is registered as the collation data.

All of xx pay, yy pay, and zz pay are settlement means that may be used by the user 20.

Note that the example of registering the collation data illustrated in FIG. 3 is an example, and for example, in addition to this, a user utterance such as “I'll pay with xx card” or “I'll pay with yy credit”, which is another utterance designating a settlement first stage, may be registered as the collation data.

After the collation data regarding the payment means is registered in the user terminal 100 according to the sequence illustrated in FIG. 3, the actual settlement processing described above with reference to FIG. 2 is possible.

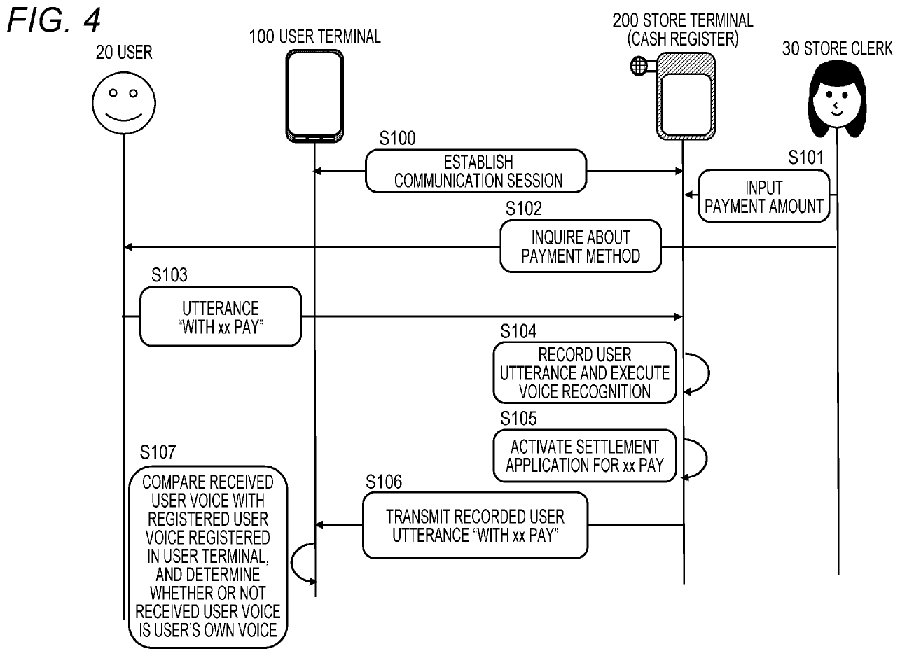

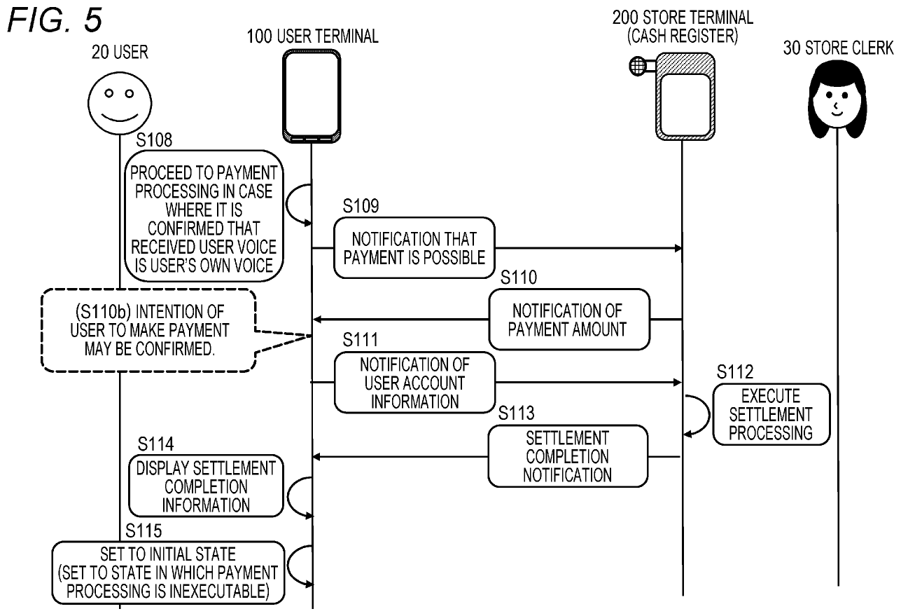

A sequence of the settlement processing will be described with reference to FIGS. 4 and 5.

FIGS. 4 and 5 illustrate, from the left, the user 20, the user terminal 100 owned by the user 20, the store terminal 200, and a store clerk 30 of a store where the store terminal 200 is placed.

The processing is performed in the order of steps S100 to S115 illustrated in FIGS. 4 and 5.

Hereinafter, processing of each step will be sequentially described.

(Step S100)

First, in step S100, a communication session is established between the store terminal 200 and the user terminal 100. That is, when the user terminal 100 approaches the store terminal 200 and reaches a position where short-range wireless communication is possible, the communication session is established between the two terminals, and the two terminals are set to a communicable state.

Note that, as described above, the short-range wireless communication executed between the store terminal 200 and the user terminal 100 is, for example, short-range wireless communication such as Bluetooth (registered trademark) (BT) communication, near field communication (NFC) communication, radio frequency (RF) communication, or ultra wide band (UWB) communication.

(Step S101)

Next, the store clerk inputs a payment amount to the store terminal 200.

Note that, here, the description will be made assuming that the store clerk 30 executes the input of the payment amount, but for example, processing may be performed in which the user 20 causes a scanner connected to the store terminal 200 to read a tag of a product. Furthermore, the settlement amount may be automatically calculated by the store terminal 200 receiving data transmitted from an RFID tag attached to the product.

(Step S102)

Next, the store clerk 30 inquires of the user 20 about a payment method (settlement means). That is, a question is asked.

Note that the inquiry about the payment means may also be made by use of a voice output from the store terminal 200.

(Step S103)

Next, in step S103, the user 20 makes an utterance indicating the payment means. For example, the user 20 utters “with xx pay”. The user 20 makes the same utterance as that in the collation data registered in the user terminal 100.

(Step S104)

Next, in step S104, the store terminal 200 records, in a storage unit, the user utterance “with xx pay” input via the microphone, and further executes voice recognition.

With this voice recognition, it is confirmed that the user 20 requests settlement using [xx pay].

(Step S105)

Next, in step S105, the store terminal 200 activates a settlement application (application program) for performing the settlement means requested by the user.

(Step S106)

Next, in step S106, the store terminal 200 transmits the voice data of the user utterance “with xx pay”, which is recorded in the storage unit in step S104, to the user terminal 100 by using short-range wireless communication.

(Step S107)

Next, in step S107, the user terminal 100 compares the voice data of the user utterance “with xx pay”, which is received from the store terminal 200 in step S106, with the voice data of the user utterance “with xx pay”, which is registered in advance in the user terminal 100, and determines whether or not the pieces of voice data match each other.

Note that, in the determination as to whether or not the pieces of voice data match each other, it is determined that the pieces of voice data match each other not only in the case of exact matching but also in a case where a difference falls within a predetermined error range.

(Step S108)

In a case where it is determined in step S107 that the user utterance “with xx pay” received from the store terminal 200 and the registered user utterance “with xx pay” registered in the user terminal 100 match each other, the user terminal 100 proceeds to the payment processing in step S108.

Note that, in a case where it is not confirmed in step S107 that the two utterances match each other, the user terminal 100 sends an error notification to the store terminal 200, and subsequent processing in and after step S109 is not executed.

However, even in this case, processing of requesting the user 20 to confirm an intention to make payment again may be executed. This processing sequence will be described later.

(Step S109)

When it is determined in step S107 that the two utterances match each other and it is confirmed that the utterance made by the user 20 in step S103 is an utterance of the user 20 himself, the user terminal 100 notifies the store terminal 200 that the payment is possible in step S109.

(Step S110)

Next, in step S110, the store terminal 200 notifies the user terminal 100 of the payment amount.

Note that, at this point, as processing of (step S110b), processing of requesting the user 20 to confirm the intention to make payment may be performed.

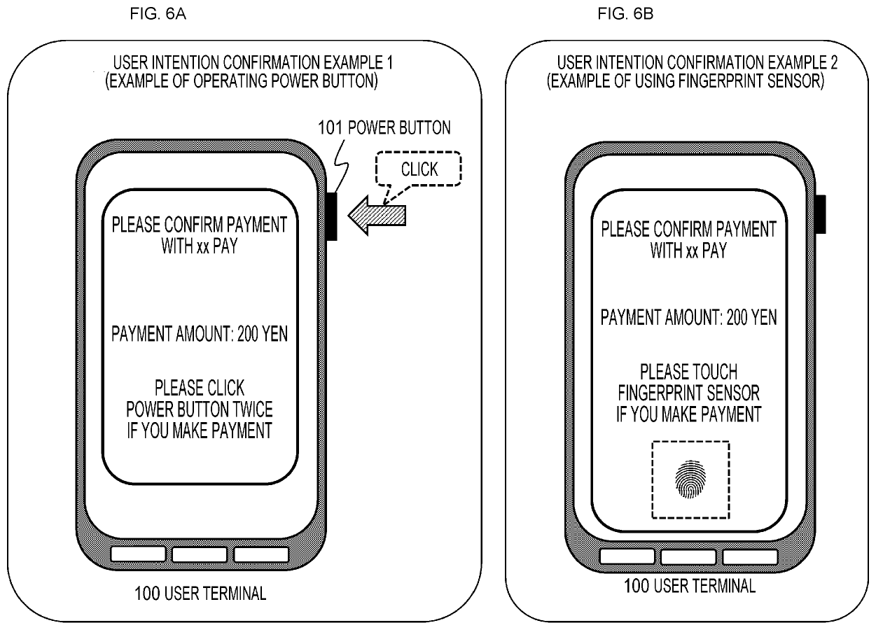

Specifically, when the user terminal 100 is notified of the payment amount in step S110, display data as illustrated in FIG. 6 is transmitted from the store terminal 200 to the user terminal 100 and displayed on the user terminal 100.

FIG. 6 illustrates two examples of the display data for user intention confirmation.

FIG. 6(1) illustrates display data for causing the user to operate a power button 101 in a case where the user has the intention to make payment. When the user operates the power button 101, notification data indicating the intention to make payment is transmitted from the user terminal 100 to the store terminal 200 in response to the operation.

FIG. 6(2) illustrates display data for causing the user to perform an operation of touching a fingerprint sensor in a case where the user has the intention to make payment. When the user touches the fingerprint sensor, first, the user terminal 100 performs collation processing with fingerprint data recorded in the storage unit of the user terminal 100. In a case where the collation is established, the notification data indicating the intention to make payment is transmitted from the user terminal 100 to the store terminal 200.

Note that these types of processing are executed by an application in the user terminal 100, for example, a settlement application for code settlement using a QR code (registered trademark) or the like compatible with xx pay.

(Step S111)

Next, in step S111, the user terminal 100 transmits account information or the like of the user 20, which is necessary for the settlement processing, to the store terminal 200.

Note that the transmitted information is different information depending on the settlement means to be used by the user 20.

(Step S112)

Next, in step S112, the store terminal 200 executes the settlement processing according to the user account information received from the user terminal 100.

(Step S113)

Next, in step S113, the store terminal 200 transmits a settlement completion notification to the user terminal 100.

(Step S114)

Next, in step S114, the user terminal 100 displays the settlement completion notification received from the store terminal 200.

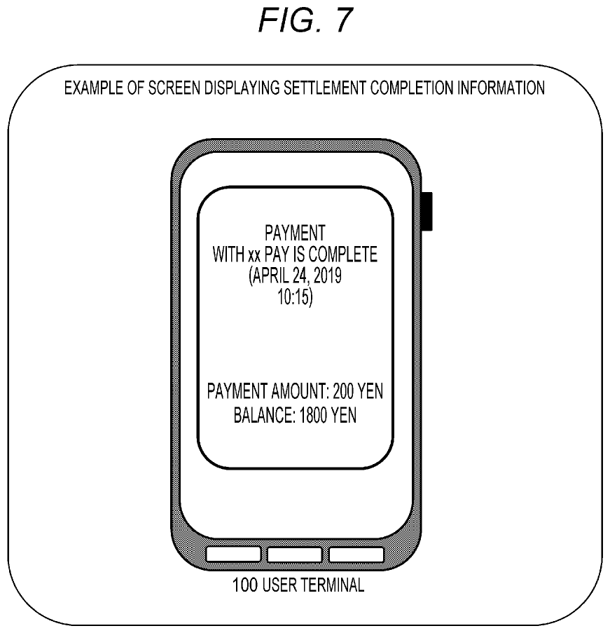

For example, data as illustrated in FIG. 7 is displayed.

(Step S115)

Next, in step S115, the user terminal 100 sets the user terminal 100 to an initial state. That is, the user terminal 100 is set to a state in which payment processing is inexecutable.

Through the series of processing, the store terminal 200 can confirm that the settlement means that the user 20 intends to execute by use of the user terminal 100 is “xx pay”, and perform the settlement processing to which the confirmed settlement means “xx pay” is applied.

As understood from the above description, in the confirmation processing of the settlement means, the user utterance made in step S103 is transmitted from the store terminal 200 to the user terminal 100 in step S106, and the user terminal 100 executes the collation processing between the received utterance and the registered user utterance registered in advance in the user terminal 100.

In a case where, in this collation processing, it is confirmed that the input utterance matches the registered utterance, the settlement processing is performed.

The above-described processing can be executed only by the settlement processing execution user (customer) himself, the settlement is not made in a case where impersonation processing by another person is performed, and thus safer settlement processing is achieved.

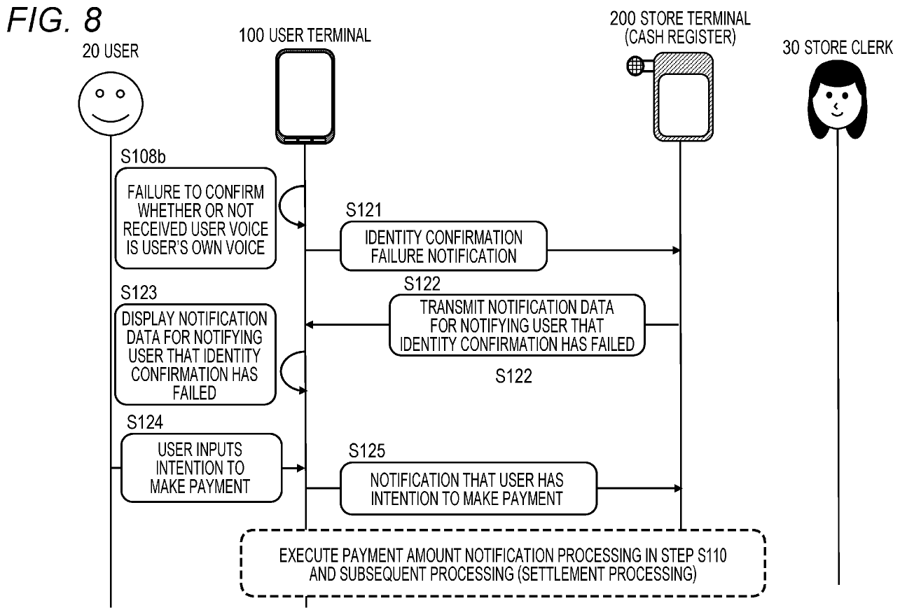

Note that, as described above, in a case where it is not confirmed that the two utterances match each other in the collation processing of the user utterances in step S107, the processing of requesting the user 20 to confirm the intention to make payment again may be executed. This processing sequence will be described with reference to FIG. 8.

FIG. 8 is a sequence diagram for describing an example of processing subsequently executed in a case where the user terminal 100 fails in the collation processing between the user utterance received from the store terminal 200 and the registered user utterance recorded in advance in the user terminal 100 in step S108b corresponding to step S108 illustrated in FIG. 5.

Processing in and after step S108b will be described.

(Step S108b)

In a case where, in step S108b, the user terminal 100 cannot confirm that the user utterance “with xx pay” received from the store terminal 200 and the registered user utterance “with xx pay” registered in the user terminal 100 match each other, processing in and after step S121 is executed.

(Step S121)

In this case, in step S121, the user terminal 100 transmits an identity confirmation failure notification to the store terminal 200.

(Step S122)

In response to reception of the identity confirmation failure notification from the user terminal 100, in step S122, the store terminal 200 transmits, to the user terminal 100, notification data for notifying the user that the identity confirmation processing based on the user utterance collation processing in the user terminal 100 has failed.

(Step S123)

The user terminal 100 displays, on the user terminal 100, the notification data received from the store terminal 200, that is, the notification data indicating that the identity confirmation processing based on the user utterance collation processing has failed.

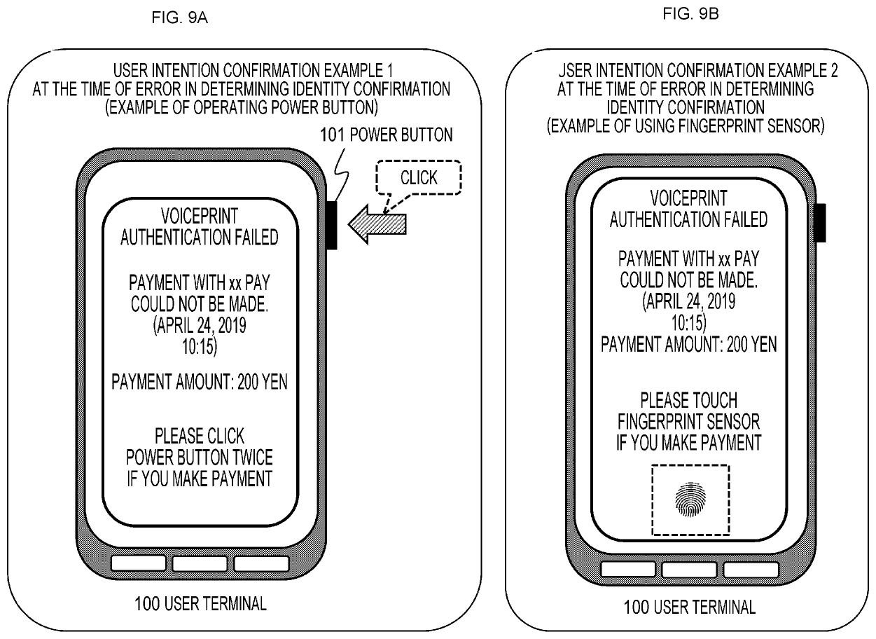

Specifically, for example, display data as illustrated in FIG. 9 is displayed on the user terminal 100.

FIG. 9 illustrates two examples of the display data for displaying the notification data indicating that the identity confirmation processing based on the user utterance collation processing has failed and for confirming the intention of the user to make payment.

FIG. 9(1) illustrates display data for causing the user to operate the power button 101 in a case where the user has the intention to make payment. When the user operates the power button 101, the notification data indicating the intention to make payment is transmitted from the user terminal 100 to the store terminal 200 in response to the operation.

FIG. 9(2) illustrates display data for causing the user to perform an operation of touching the fingerprint sensor in a case where the user has the intention to make payment. When the user touches the fingerprint sensor, first, the user terminal 100 performs collation processing with the fingerprint data recorded in the storage unit of the user terminal 100. In a case where the collation is established, the notification data indicating the intention to make payment is transmitted from the user terminal 100 to the store terminal 200.

Note that these types of processing are executed by an application in the user terminal 100, for example, a settlement application compatible with code settlement using a QR code (registered trademark) or the like compatible with xx pay.

(Steps S124 to S125)

When the user performs, in step S124, an operation indicating the intention to make payment on the display data displayed on the user terminal 100 in step S123, the notification data indicating the intention to make payment based on the operation information is transmitted from the user terminal 100 to the store terminal 200.

The series of processing is executed by an application in the user terminal 100, for example, the settlement application compatible with xx pay.

Thereafter, normal settlement processing is executed. Specifically, the processing in and after step S110 illustrated in FIG. 5 is executed.

### 3. (Second Embodiment) Embodiment in which Store Terminal Selects Terminal to Make Settlement from Plurality of User Terminals

Next, as a second embodiment, an embodiment will be described in which a store terminal selects a terminal to make settlement from a plurality of user terminals.

As described above with reference to FIG. 1, the store terminal performs short-range wireless communication with the user terminal to perform settlement processing.

However, when there is a plurality of different user terminals in a range in which short-range communication can be performed with the store terminal, the store terminal communicates with the plurality of user terminals in parallel, and it is necessary to perform processing of determining which user terminal among the plurality of user terminals is the terminal that performs the settlement processing.

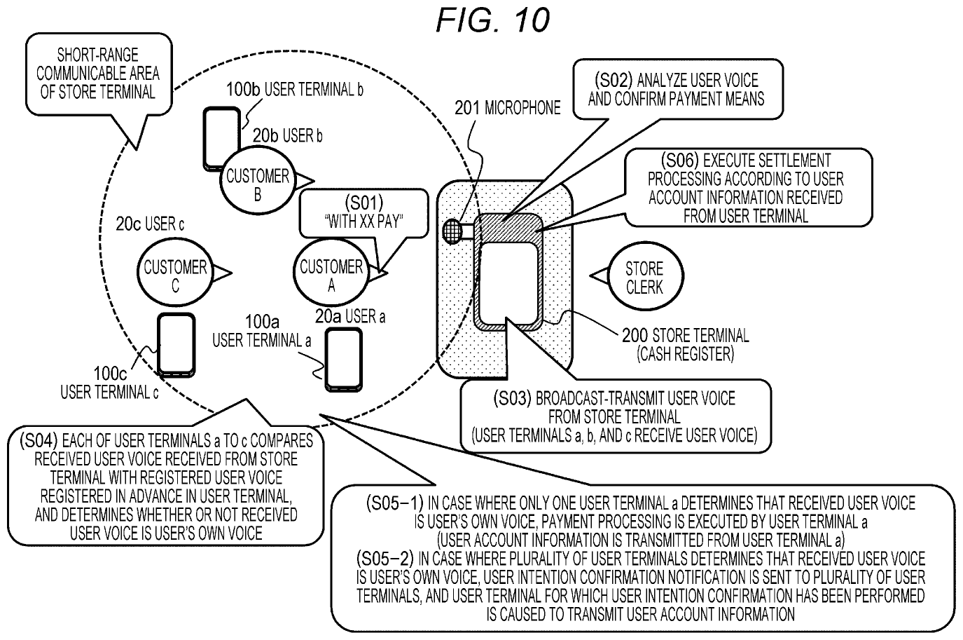

FIG. 10 is a diagram for describing exemplary processing executed by a store terminal 200 as an information processing device of the present disclosure.

The store terminal (cash register) 200 includes a microphone 201.

In FIG. 10, the store terminal 200 is placed in front of a store clerk, and a user a (customer A) 20a who intends to make tapless settlement stands in front of the store terminal 200.

The user a (customer A) 20a holds a user terminal 100a such as a smartphone.

Short-range wireless communication is performed between the store terminal 200 and the user terminal 100a, and settlement processing is executed.

However, in a short-range communicable area of the store terminal 200 indicated by a dotted circle in FIG. 10, a user terminal 100b of a user b (customer B) 20b and a user terminal 100c of a user c (customer C) 20c are also present in addition to the user terminal 100a of the user a (customer A) 20a.

As a result, the store terminal 200 communicates with the three user terminals a, b, and c in parallel.

The store terminal 200 needs to select the user terminal that executes the settlement processing from the three user terminals a, b, and c to perform the settlement processing.

The settlement processing by the store terminal 200 of the present disclosure is performed in the order of steps S01 to S06 illustrated in FIG. 10. Hereinafter, processing of each step will be described.

(Step S01)

First, the user a (customer A) 20a utters a settlement means.

As an example, it is assumed that the user a (customer A) 20a utters “with XX pay”.

(Step S02)

The store terminal 200 inputs the utterance of the user a (customer A) 20a “with XX pay” via the microphone 201, and in step S02, a data processing unit in the store terminal 200 executes voice analysis of the input utterance and determines that the user who intends to perform the settlement processing, that is, the user a (customer A) 20a wants to use [XX pay] as the settlement means.

(Step S03)

Next, in step S03, the store terminal 200 broadcast-transmits the utterance voice of the user a (customer A) 20a “with XX pay” to the user terminals within the short-range wireless communicable area by using short-range wireless communication.

In the example illustrated in FIG. 10, in addition to the user terminal 100a of the user a (customer A) 20a, the user terminal 100b of the user b (customer B) 20b and the user terminal 100c of the user c (customer C) 20c are also present in the short-range wireless communicable area, and the store terminal 200 transmits the utterance voice of the user a (customer A) 20a “with XX pay” to these three user terminals a, b, and c by using short-range wireless communication.

(Step S04)

Next, in step S04, each of the user terminals a to c compares the received user voice received from the store terminal 200 with a registered user voice registered in advance in the user terminal, and executes processing of determining whether or not the received user voice is the user's own voice.

Note that an utterance voice of the owner of each terminal is registered in advance in a corresponding one of the user terminals a to c. This is collation data registered in advance in the terminal by each user according to the sequence described above with reference to FIG. 3.

In a case where, in step S04, the user terminal 100a confirms that the received user voice received from the store terminal 200 matches the registered user voice registered in advance in the user terminal 100a, it is determined that the user voice received from the store terminal 200 is the user's own voice.

In this case, processing in and after step S05 is executed.

In a case where the matching is not confirmed, an error notification is sent from the user terminal 100a to the store terminal 200, and the processing in and after step S05 is not executed.

(Step S05-1)

In a case where, in step S04, only one user terminal a, 100a determines that the received user voice is the user's own voice, the payment processing is executed by the user terminal a, 100a. For example, processing of transmitting user account information from the user terminal a, 100a to the store terminal 200 is executed.

(Step S05-2)

On the other hand, in a case where, in step S04, a plurality of user terminals determines that the received user voice is the user's own voice, the store terminal 200 sends a user intention confirmation notification to the plurality of user terminals, and causes a user terminal for which the user intention confirmation has been performed to transmit the user account information.

In the collation processing based on the user utterance voice, a possibility of making erroneous determination is not low. Therefore, there is a possibility that an utterance that is not the user's own voice may be determined to be the user's own voice.

Step S05-2 is processing assuming such erroneous determination.

As described above, in a case where erroneous determination is made in step S04 and the plurality of user terminals determines that the received user voice is the user's own voice, the store terminal 200 sends the user intention confirmation notification to the plurality of user terminals, and causes the user terminal for which the user intention confirmation has been performed to transmit the user account information.

A specific sequence of this processing will be described later.

(Step S06)

Next, in step S06, the store terminal 200 executes the settlement processing according to the user account information received from the user terminal 100.

Through the series of processing, the store terminal 200 can discriminate and select one user terminal to execute the settlement processing from the plurality of user terminals, and communicate with the selected user terminal to perform the settlement processing.

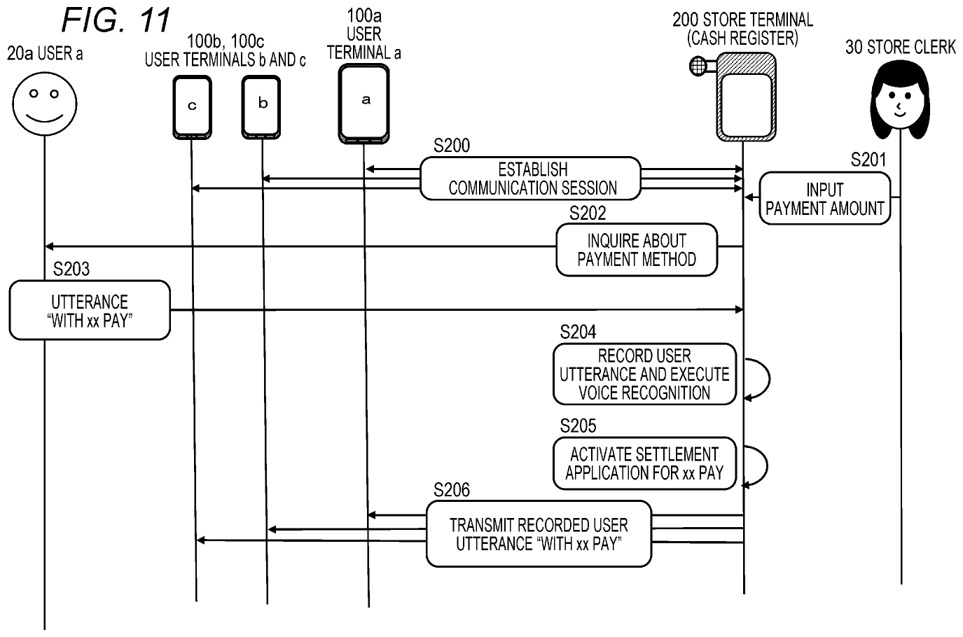

Next, a detailed processing sequence of the second embodiment will be described with reference to FIGS. 11 to 13.

FIGS. 11 to 13 illustrate, from the left,

the user a, 20a,

the user terminal c, 100c owned by the user 20c,

the user terminal b, 100b owned by the user 20b,

the user terminal a, 100a owned by the user 20a,

the store terminal 200, and

a store clerk 30 of a store where the store terminal 200 is placed.

These are illustrated.

The processing is performed in the order of steps S200 to S216 illustrated in FIGS. 11 to 13.

Hereinafter, processing of each step will be sequentially described.

(Step S200)

First, in step S200, a communication session is established between the store terminal 200 and the user terminals a to c, 100a to 100c. That is, when the user terminals a to c, 100a to 100c enter the short-range wireless communicable area of the store terminal 200 and reach a position where short-range wireless communication is possible, the communication session is established between the store terminal 200 and the user terminals a to c, 100a to 100c, and these terminals are set to a communicable state.

Note that, as described above, the short-range wireless communication executed between the store terminal 200 and the user terminals a to c, 100a to 100c is, for example, short-range wireless communication such as Bluetooth (registered trademark) (BT) communication, near field communication (NFC) communication, radio frequency (RF) communication, or ultra wide band (UWB) communication.

(Step S201)

Next, the store clerk inputs a payment amount to the store terminal 200.

Note that, here, the description will be made assuming that the store clerk 30 executes the input of the payment amount, but for example, processing may be performed in which the user 20 causes a scanner connected to the store terminal 200 to read a tag of a product. Furthermore, the settlement amount may be automatically calculated by the store terminal 200 receiving data transmitted from an RFID tag attached to the product.

(Step S202)

Next, the store clerk 30 inquires of the user 20 about a payment method (settlement means). That is, a question is asked.

Note that the inquiry about the payment means may also be made by use of a voice output from the store terminal 200.

(Step S203)

Next, in step S203, the user a, 20a makes an utterance indicating the payment means. For example, the user a, 20a utters “with xx pay”. The user a, 20a makes the same utterance as that in the collation data registered in the user terminal a, 100a.

(Step S204)

Next, in step S204, the store terminal 200 records, in a storage unit, the user utterance “with xx pay” input via the microphone, and further executes voice recognition.

With this voice recognition, it is confirmed that the user a, 20a requests settlement using [xx pay].

(Step S205)

Next, in step S205, the store terminal 200 activates a settlement application (application program) for performing the settlement means requested by the user a, 20a.

(Step S206)

Next, in step S206, the store terminal 200 broadcast-transmits the voice data of the user utterance of the user a, 20a “with xx pay”, which is recorded in the storage unit in step S204.

The transmitted data is received by the three user terminals a to c, 100a to 100c in the short-range wireless communicable area of the store terminal 200.

(Step S207)

Next, in step S207, the three user terminals a to c, 100a to 100c, which have received the voice data of the user utterance of the user a, 20a “with xx pay” from the store terminal 200, compare the user utterance “with xx pay” received from the store terminal 200 in step S206 with the user utterances for collation each registered in advance in a corresponding one of the three user terminals a to c, 100a to 100c, and determine whether or not the pieces of voice data match each other.

Note that, in the determination as to whether or not the pieces of voice data match each other, it is determined that the pieces of voice data match each other not only in the case of exact matching but also in a case where a difference falls within a predetermined error range.

(Steps S208 to S209)

In step S207, it is assumed that only the user terminal a, 100a of the user a, 20a determines that the user utterance “with xx pay” received from the store terminal 200 and the registered user utterance “with xx pay” registered in the user terminal a, 100a match each other. In this case, in step S208, only the user terminal a, 100a of the user a, 20a proceeds to the payment processing.

In this case, in step S209, the user terminal a, 100a notifies the store terminal 200 that the payment is possible.

(Step S210)

The user terminals b and c other than the user terminal a, 100a of the user a, 20a determine that the utterances do not match each other in the utterance collation processing in step S107. As a result, in step S210, the user terminals b and c send an error notification to the store terminal 200.

(Step S211)

Next, in step S211, the store terminal 200 notifies the user terminal a, 100a of the payment amount.

Note that, at this point, as processing of (step S211b), processing of requesting the user a, 20a to confirm an intention to make payment may be performed.

Specifically, when the user terminal a, 100a is notified of the payment amount in step S211, display data as illustrated in FIG. 6 described above is transmitted from the store terminal 200 to the user terminal a, 100a and displayed on the user terminal a, 100a.

(Step S212)

Next, in step S212, the user terminal a, 100a transmits account information or the like of the user a, 100a, which is necessary for the settlement processing, to the store terminal 200.

Note that the transmitted information is different information depending on the settlement means to be used by the user a, 100a.

(Step S213)

Next, in step S213, the store terminal 200 executes the settlement processing according to the user account information received from the user terminal a, 100a.

(Step S214)

Next, in step S214, the store terminal 200 transmits a settlement completion notification to the user terminal a, 100a.

(Step S215)

Next, in step S215, the user terminal a, 100a displays the settlement completion notification received from the store terminal 200.

For example, data as illustrated in FIG. 7 described above is displayed.

(Step S216)

Next, in step S216, the user terminal a, 100a sets the user terminal a, 100a to an initial state. That is, the user terminal a, 100a is set to a state in which payment processing is inexecutable.

Through the series of processing, even in a case where there is a plurality of user terminals in the short-range wireless communicable area of the store terminal 200, the store terminal 200 can discriminate and select one user terminal to perform the settlement processing from among the user terminals, and communicate with the selected user terminal to perform the correct settlement processing.

As understood from the above description, in the discrimination processing of the settlement terminal, each user terminal executes the collation processing of the user utterance.

One user terminal for which the collation is established in the collation processing is selected as the user terminal that executes the correct settlement processing.

However, as described above in (Step S05-2) of FIG. 10, the collation processing based on the utterance voice data does not necessarily obtain a 100 percent correct result, and may make erroneous determination.

In such a case, confirmation processing for the user is performed again.

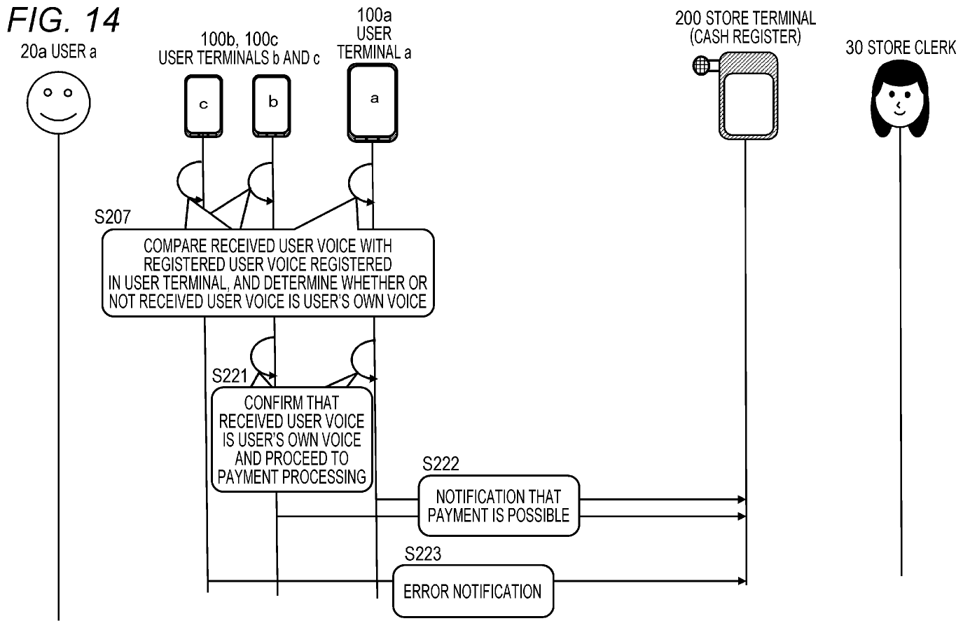

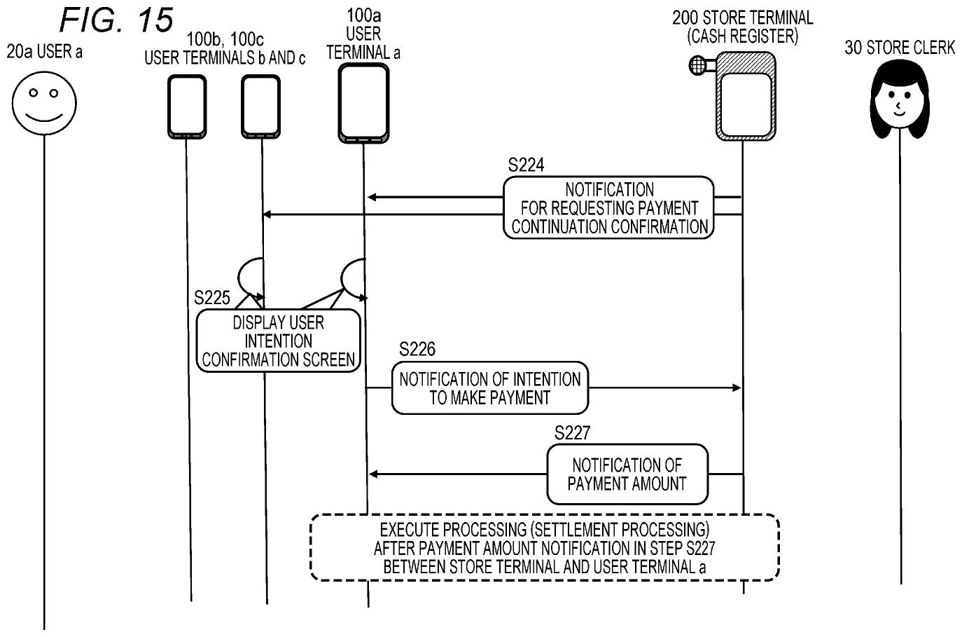

A sequence involving the confirmation processing for the user will be described with reference to FIGS. 14 to 15.

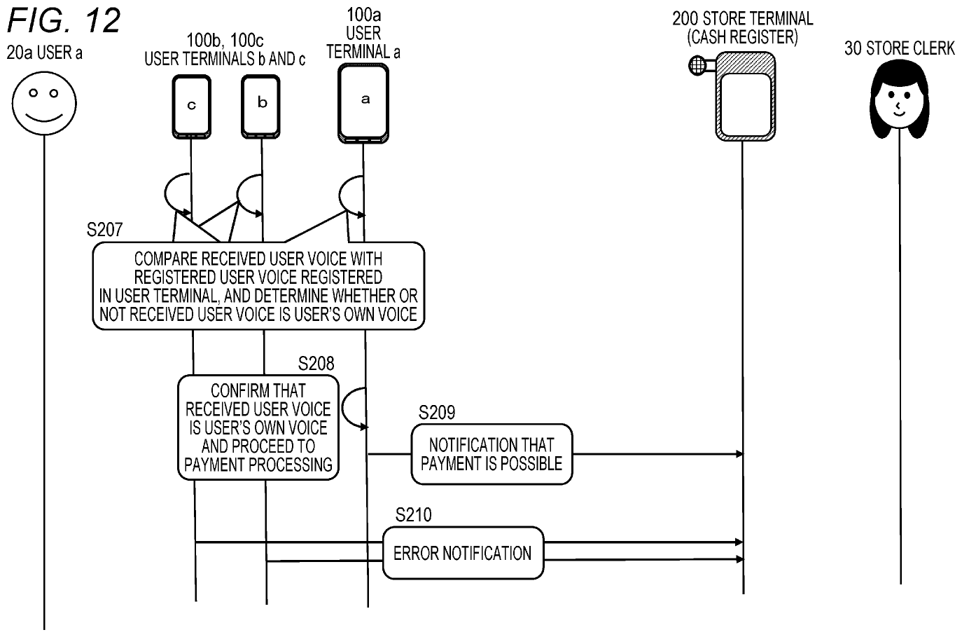

FIGS. 14 and 15 illustrate a sequence following the collation processing of the utterance voice data in step S207, which has been described above with reference to FIG. 12.

FIGS. 14 and 15 illustrate a processing sequence in a case where the user terminal b, 100b makes erroneous determination in the collation processing of the utterance voice data in step S207.

This is a processing sequence in a case where the user terminal b, 100b erroneously determines that the user utterance made in step S203, that is, the user utterance transmitted from the store terminal 200 in step S206 matches the registered data for collation preregistered in the user terminal b, 100b.

Processing of each of step S221 and subsequent steps, which follow step S207, will be described.

(Steps S221 to S222)

In step S221, the user terminal a, 100a of the user a, 20a determines that the user utterance “with xx pay” received from the store terminal 200 and the registered user utterance “with xx pay” registered in the user terminal a, 100a match each other.

Moreover, the user terminal b, 100b of the user b, 20b also determines that the user utterance “with xx pay” received from the store terminal 200 and the registered user utterance “with xx pay” registered in the user terminal b, 100b match each other. This determination is erroneous determination.

In this case, two user terminals of the user terminal a, 100a of the user a, 20a and the user terminal b, 100b of the user b, 20b perform processing of notifying the store terminal 200 that the payment is possible in step S222.

(Step S223)

The user terminal c determines that the utterances do not match each other in the utterance collation processing in step S207, and the user terminal c sends an error notification to the store terminal 200 in step S223.

(Steps S224 to S225)

When receiving the notification indicating that the payment is possible based on the establishment of the utterance voice collation from the plurality of user terminals in step S222, the store terminal 200 sends a notification for requesting payment continuation confirmation to the plurality of terminals in step S224. The notification for requesting payment continuation confirmation is a notification for causing each user terminal to perform processing of displaying display data for confirming the intention of the user to make payment.

In step S225, each user terminal that has received the notification for requesting payment continuation confirmation from the store terminal 200 displays the display data for confirming the intention of the user on the user terminal.

Specifically, display data as illustrated in FIG. 6 described above is displayed on the user terminal a, 100a and the user terminal b, 100b.

(Step S226)

The user a, 20a performs an operation indicating the intention to make payment on the display data for user intention confirmation displayed on the user terminal a, 100a.

On the other hand, the user b, 20b does not perform the operation indicating the intention to make payment on the display data for user intention confirmation displayed on the user terminal b, 100b.

As a result, in step S226, only the user terminal a, 100a notifies the store terminal 200 of the intention to make payment.

(Step S227)

Next, in step S227, the store terminal 200 notifies only the user terminal a, 100a of the user a, 20a of the payment amount.

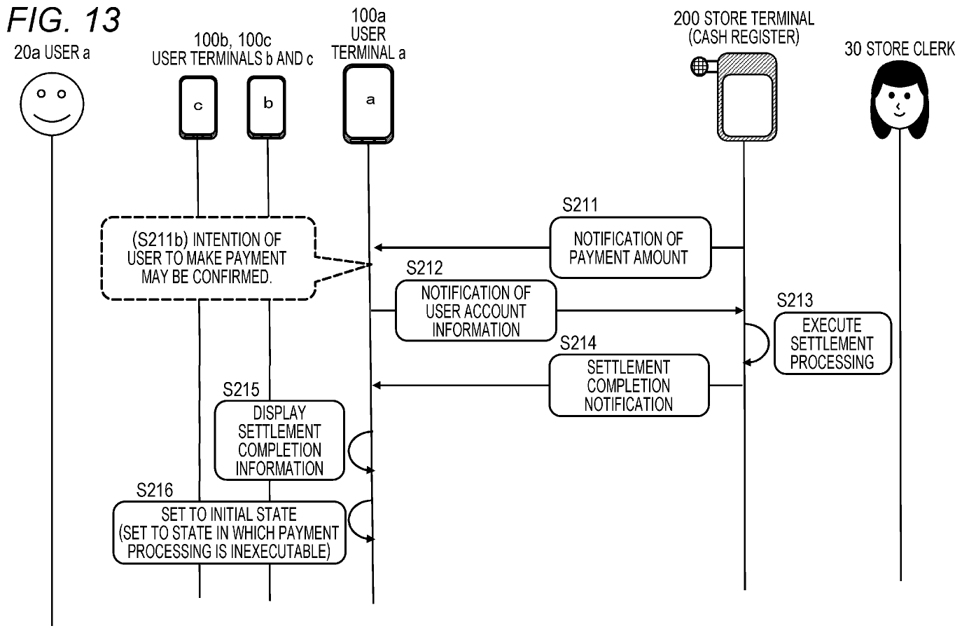

Thereafter, processing similar to that in and after step S212 described with reference to FIG. 13 is executed.

As described above, in the processing of the present disclosure, even in a case where a user terminal makes erroneous determination based on a user utterance voice, confirming an intention of a user makes it possible to perform correct settlement processing without an error.

Note that, if a plurality of user terminals is not present in the short-range wireless communicable area of the store terminal 200, it is possible to prevent occurrence of the above-described problem, that is, the problem that the store terminal 200 is simultaneously connected to the plurality of user terminals.

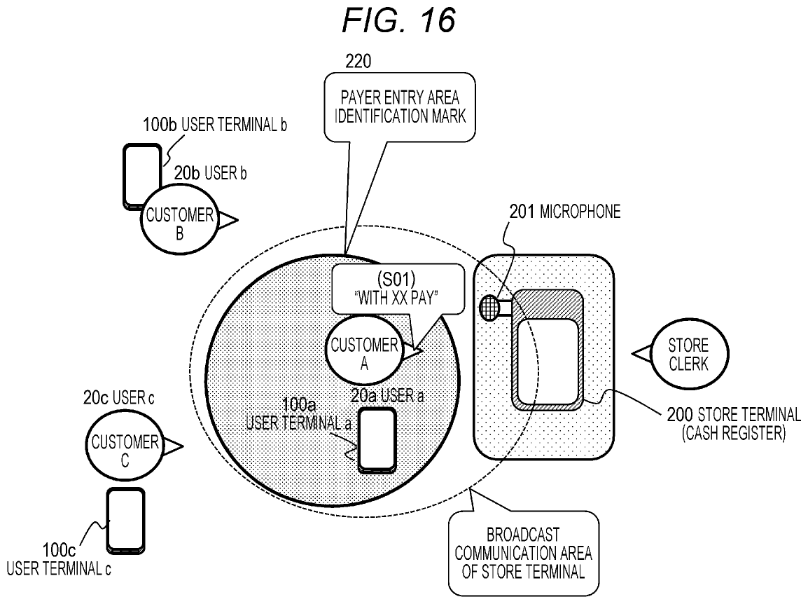

It is effective to adopt, as a configuration for this purpose, for example, a configuration in which a payer entry area identification mark 220 as illustrated in FIG. 16 is set according to the short-range wireless communicable area of the store terminal 200.

A user enters the payer entry area identification mark 220 only in a case where the user himself makes payment, and performs settlement processing.

With such a configuration, a plurality of user terminals is not present in the short-range wireless communicable area of the store terminal 200, and the store terminal 200 can reliably communicate with one user terminal, that is, one user terminal that performs settlement processing, and can perform the correct settlement processing.

### 4. (Third Embodiment) Embodiment in which Settlement Processing is Performed in Unattended Store without Store Clerk

Next, as a third embodiment, an embodiment will be described in which settlement processing is performed in an unattended store without a store clerk.

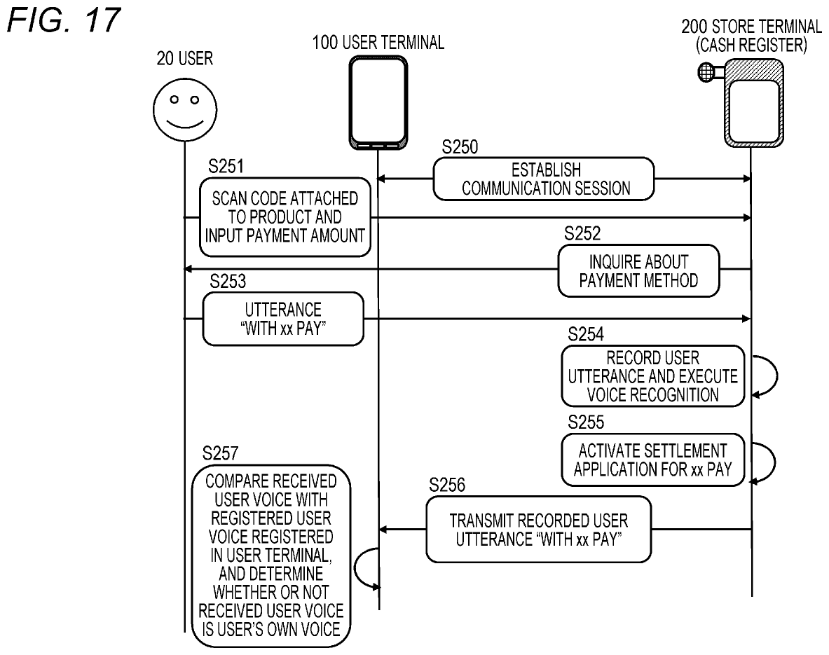

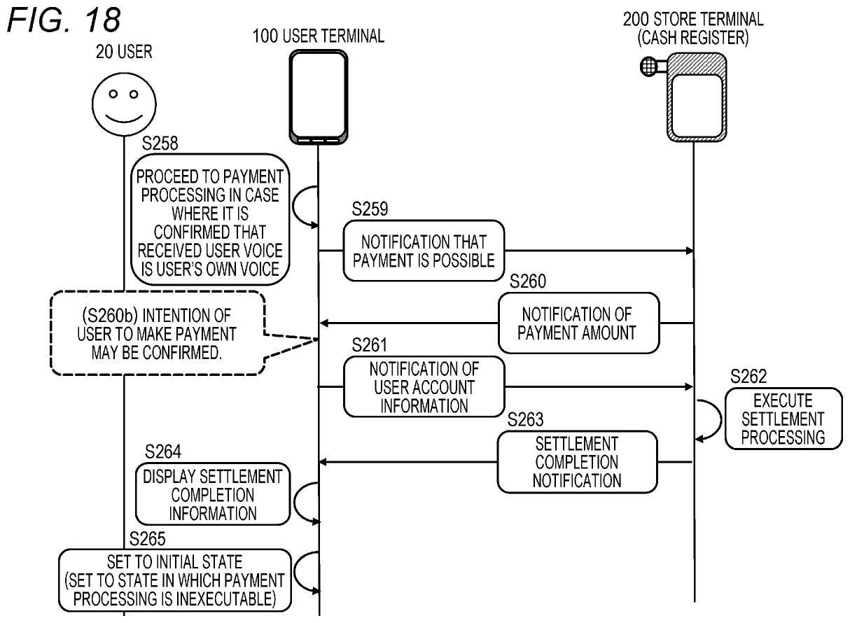

A processing sequence of the third embodiment will be described with reference to FIGS. 17 and 18.

FIGS. 17 and 18 illustrate, from the left, a user 20, a user terminal 100 owned by the user 20, and a store terminal 200.

The processing is performed in the order of steps S250 to S265 illustrated in FIGS. 17 and 18.

Hereinafter, processing of each step will be sequentially described.

(Step S250)

First, in step S250, a communication session is established between the store terminal 200 and the user terminal 100. That is, when the user terminal 100 approaches the store terminal 200 and reaches a position where short-range wireless communication is possible, the communication session is established between the two terminals, and the two terminals are set to a communicable state.

(Step S251)

Next, the user 20 causes a scanner connected to the store terminal 200 to read a tag of a product, and inputs a payment amount to the store terminal 200.

Note that the settlement amount may be automatically calculated by the store terminal 200 receiving data transmitted from an RFID tag attached to the product.

(Step S252)

Next, the store terminal 200 inquires of the user 20 about a payment method (settlement means) via a speaker of the store terminal 200. That is, a question is asked. Voice data for the inquiry is recorded in advance in a storage unit of the store terminal 200.

(Step S253)

Next, in step S253, the user 20 makes an utterance indicating the payment means. For example, the user 20 utters “with xx pay”. The user 20 makes the same utterance as that in collation data registered in the user terminal 100.

(Step S254)

Next, in step S254, the store terminal 200 records, in the storage unit, the user utterance “with xx pay” input via a microphone, and further executes voice recognition.

With this voice recognition, it is confirmed that the user 20 requests settlement using [xx pay].

(Step S255)

Next, in step S255, the store terminal 200 activates a settlement application (application program) for performing the settlement means requested by the user.

(Step S256)

Next, in step S256, the store terminal 200 transmits the voice data of the user utterance “with xx pay”, which is recorded in the storage unit in step S254, to the user terminal 100 by using short-range wireless communication.

(Step S257)

Next, in step S257, the user terminal 100 compares the voice data of the user utterance “with xx pay”, which is received from the store terminal 200 in step S256, with the voice data of the user utterance “with xx pay”, which is registered in advance in the user terminal 100, and determines whether or not the pieces of voice data match each other.

Note that, in the determination as to whether or not the pieces of voice data match each other, it is determined that the pieces of voice data match each other not only in the case of exact matching but also in a case where a difference falls within a predetermined error range.

(Step S258)

In a case where it is determined in step S257 that the user utterance “with xx pay” received from the store terminal 200 and the registered user utterance “with xx pay” registered in the user terminal 100 match each other, the user terminal 100 proceeds to the payment processing in step S258.

Note that, in a case where it is not confirmed in step S257 that the two utterances match each other, the user terminal 100 sends an error notification to the store terminal 200, and subsequent processing in and after step S259 is not executed.

(Step S259)

When it is determined in step S257 that the two utterances match each other and it is confirmed that the utterance made by the user 20 in step S253 is an utterance of the user 20 himself, the user terminal 100 notifies the store terminal 200 that the payment is possible in step S259.

(Step S260)

Next, in step S260, the store terminal 200 notifies the user terminal 100 of the payment amount.

Note that, at this point, as processing of (step S260b), processing of requesting the user 20 to confirm an intention to make payment may be performed.

Specifically, when the user terminal 100 is notified of the payment amount in step S260, the display data for confirming the intention of the user to make payment, which has been described above with reference to FIG. 6, is transmitted from the store terminal 200 to the user terminal 100 and displayed on the user terminal 100.

(Step S261)

Next, in step S261, the user terminal 100 transmits account information or the like of the user 20, which is necessary for the settlement processing, to the store terminal 200.

Note that the transmitted information is different information depending on the settlement means to be used by the user 20.

(Step S262)

Next, in step S262, the store terminal 200 executes the settlement processing according to the user account information received from the user terminal 100.

(Step S263)

Next, in step S263, the store terminal 200 transmits a settlement completion notification to the user terminal 100.

(Step S264)

Next, in step S264, the user terminal 100 displays the settlement completion notification received from the store terminal 200.

For example, data as described above with reference to FIG. 7 is displayed.

(Step S265)

Next, in step S265, the user terminal 100 sets the user terminal 100 to an initial state. That is, the user terminal 100 is set to a state in which payment processing is inexecutable.

Through the series of processing, even in a case where there is no store clerk, the store terminal 200 can confirm that the settlement means that the user 20 intends to execute by use of the user terminal 100 is “xx pay”, and perform the settlement processing to which the confirmed settlement means “xx pay” is applied.

As understood from the above description, in the confirmation processing of the settlement means, the user utterance made in step S253 is transmitted from the store terminal 200 to the user terminal 100 in step S256, and the user terminal 100 executes the collation processing between the received utterance and the registered user utterance registered in advance in the user terminal 100.

In a case where, in this collation processing, it is confirmed that the input utterance matches the registered utterance, the settlement processing is performed.

The above-described processing can be executed only by the settlement processing execution user (customer) himself, the settlement is not made in a case where impersonation processing by another person is performed, and thus safer settlement processing is achieved.

### 5. (Fourth Embodiment) Embodiment in which User Performs Settlement Processing by Making Utterance about Settlement Means to be Used Toward User Terminal Instead of Store Terminal

Next, as a fourth embodiment, an embodiment will be described in which a user performs settlement processing by making an utterance about a settlement means to be used toward a user terminal instead of a store terminal.

Each of the above-described embodiments is an embodiment in which the user performs the settlement processing by making the utterance about the settlement means to be used toward the store terminal. The fourth embodiment described below is an embodiment in which the user performs the settlement processing by making the utterance about the settlement means to be used toward the user terminal instead of the store terminal.

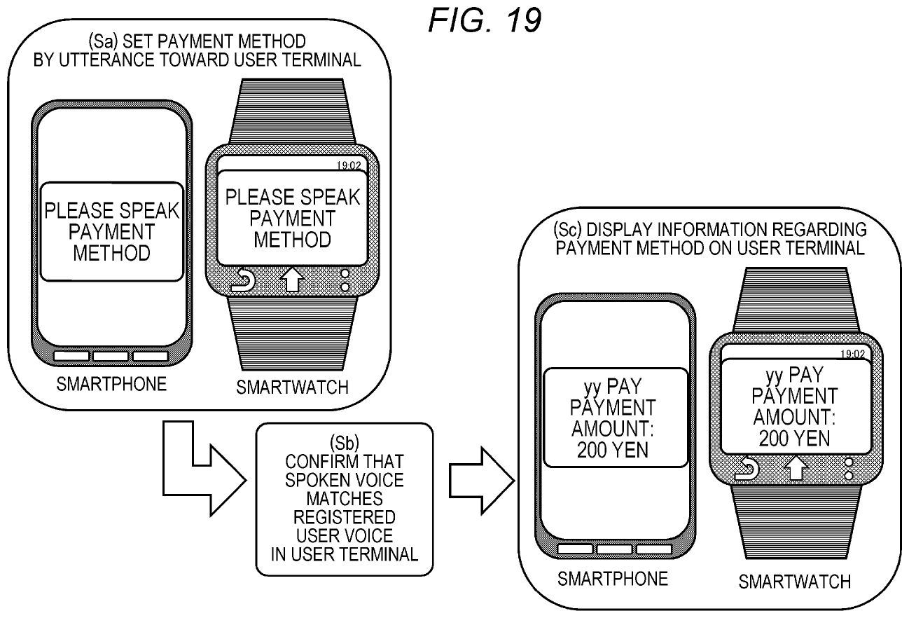

FIG. 19 is a diagram for describing an outline of processing of the fourth embodiment.

First, at the start of the settlement processing, display data illustrated in FIG. 19(Sa) is displayed on a user terminal 100.

Note that FIG. 19 illustrates examples of a smartphone and a smartwatch side by side as examples of the user terminal 100.

The display data illustrated in FIG. 19 (step Sa) is an example of display data for requesting the user to make the utterance indicating the payment method (settlement means) to be used.

The user recognizes the display data and utters, for example, “with yy pay”.

Note that, regarding the user utterance, collation data needs to be registered in advance in the user terminal.

The user utterance made toward the user terminal is input to a data processing unit in the user terminal via a microphone of the user terminal.

In FIG. 19(step Sb), the data processing unit in the user terminal determines whether or not the input user utterance matches the registered utterance for collation stored in a storage unit in the user terminal.

When the matching is confirmed, the user terminal notifies the store terminal that payment processing is to be performed.

At the time of this notification, the store terminal is also notified of information regarding the settlement means to be used, for example, settlement means information indicating that the settlement means is [yy pay].

Thereafter, payment amount information is transmitted from the store terminal to the user terminal, and settlement information illustrated in FIG. 19(c) is displayed on the user terminal.

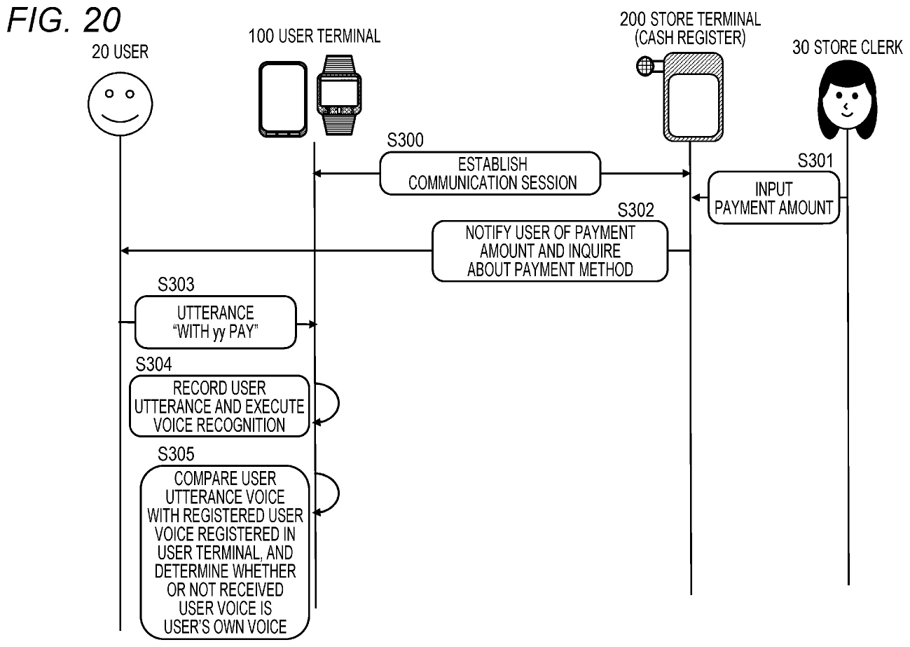

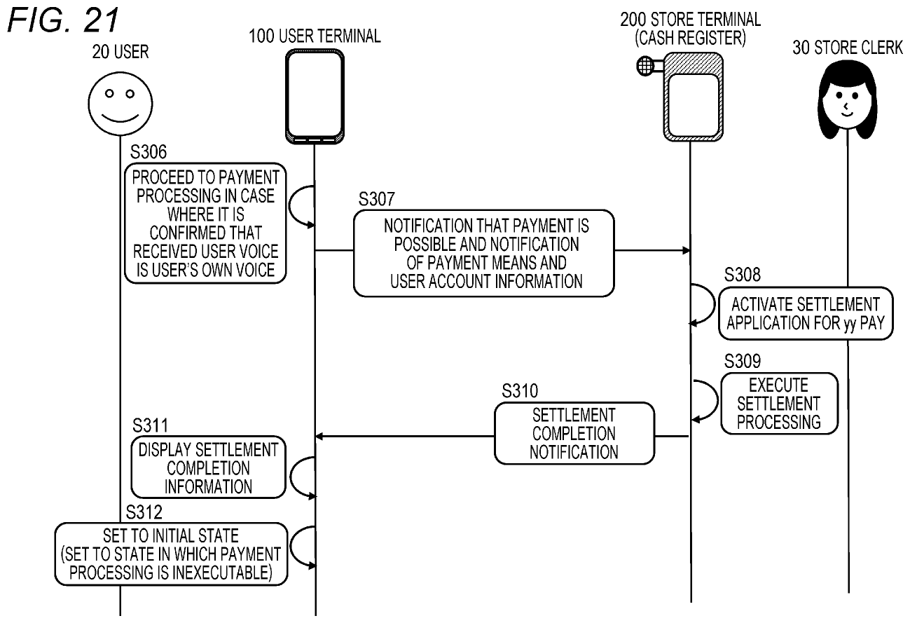

A specific sequence of the fourth embodiment will be described with reference to FIGS. 20 and 21.

FIGS. 20 and 21 illustrate, from the left, a user 20, the user terminal 100 owned by the user 20, a store terminal 200, and a store clerk 30 of a store where the store terminal 200 is placed.

The processing is performed in the order of steps S300 to S312 illustrated in FIGS. 20 and 21.

Hereinafter, processing of each step will be sequentially described.

(Step S300)

First, in step S300, a communication session is established between the store terminal 200 and the user terminal 100. That is, when the user terminal 100 approaches the store terminal 200 and reaches a position where short-range wireless communication is possible, the communication session is established between the two terminals, and the two terminals are set to a communicable state.

Note that, as described above, the short-range wireless communication executed between the store terminal 200 and the user terminal 100 is, for example, short-range wireless communication such as Bluetooth (registered trademark) (BT) communication, near field communication (NFC) communication, radio frequency (RF) communication, or ultra wide band (UWB) communication.

(Step S301)

Next, the store clerk inputs a payment amount to the store terminal 200.

Note that, here, the description will be made assuming that the store clerk 30 executes the input of the payment amount, but for example, processing may be performed in which the user 20 causes a scanner connected to the store terminal 200 to read a tag of a product. Furthermore, the settlement amount may be automatically calculated by the store terminal 200 receiving data transmitted from an RFID tag attached to the product.

(Step S302)

Next, the store terminal 200 notifies the user 20 of the payment amount, and inquires of the user 20 about the payment method (settlement means). That is, a question is asked.

(Step S303)

Next, in step S303, the user 20 makes an utterance indicating the payment means toward the user terminal 100.

Note that when the communication session is established in step S300, a settlement application is activated in the user terminal 100, and the screen illustrated above in FIG. 19(step Sa) is displayed.

Alternatively, the user may activate the settlement application to display the screen illustrated in FIG. 19(step Sa).

In step S303, the user 20 makes the utterance indicating the payment means, for example, “with yy pay”, toward the user terminal 100.

The user 20 makes the same utterance as that in the collation data registered in the user terminal 100.

(Step S304)

Next, in step S304, the user terminal 100 records, in the storage unit, the user utterance “with xx pay” input via the microphone, and further executes voice recognition.

With this voice recognition, it is confirmed that the user 20 requests settlement using [yy pay].

(Step S305)

Next, in step S305, the user terminal 100 compares the voice data of the user utterance “with yy pay”, which is input via the microphone in steps S303 and S304, with the voice data of the user utterance “with yy pay”, which is registered in advance in the user terminal 100, and determines whether or not the pieces of voice data match each other.

Note that, in the determination as to whether or not the pieces of voice data match each other, it is determined that the pieces of voice data match each other not only in the case of exact matching but also in a case where a difference falls within a predetermined error range.

(Step S306)

In a case where it is determined in step S306 that the user utterance “with yy pay” input via the microphone and the registered user utterance “with yy pay” registered in the user terminal 100 match each other, the user terminal 100 proceeds to the payment processing in step S306.

Note that, in a case where it is not confirmed in step S305 that the two utterances match each other, the user terminal 100 sends an error notification to the store terminal 200, and subsequent processing in and after step S307 is not executed.

(Step S307)

When it is determined in step S305 that the two utterances match each other and it is confirmed that the utterance made by the user 20 in step S303 is an utterance of the user 20 himself, the user terminal 100 notifies the store terminal 200 that the payment is possible in step S307.

This notification also includes the payment means (settlement means) and information necessary for the settlement processing, for example, user account information.

Note that the transmitted information is different information depending on the settlement means to be used by the user 20.

(Step S308)

Next, in step S308, the store terminal 200 activates a settlement application (application program) for performing the settlement means requested by the user.

(Step S309)

Next, in step S309, the store terminal 200 executes the settlement processing according to the user account information received from the user terminal 100.

(Step S310)

Next, in step S310, the store terminal 200 transmits a settlement completion notification to the user terminal 100.

(Step S311)

Next, in step S311, the user terminal 100 displays the settlement completion notification received from the store terminal 200.

For example, data as illustrated in FIG. 7 described above is displayed.

(Step S312)

Next, in step S312, the user terminal 100 sets the user terminal 100 to an initial state. That is, the user terminal 100 is set to a state in which payment processing is inexecutable.

Through the series of processing, the store terminal 200 can confirm that the settlement means that the user 20 intends to execute by use of the user terminal 100 is “yy pay”, and perform the settlement processing to which the confirmed settlement means “yy pay” is applied.

As understood from the above description, in the present embodiment, the user utterance made in step S303 is directly input to the user terminal 100 in the confirmation processing of the settlement means.

The user terminal 100 executes the collation processing between the input utterance and the registered user utterance registered in advance in the user terminal 100.

In a case where, in this collation processing, it is confirmed that the input utterance matches the registered utterance, the settlement processing is performed.

This utterance collation processing is processing for confirming that the input utterance is the utterance of the settlement processing execution user (customer) himself, the settlement is not made in a case where impersonation processing by another person is performed, and thus safe settlement processing is achieved.

### 6. (Fifth Embodiment) Embodiment in which Piece of Utterance Data Selected by User from Plurality of Pieces of Utterance Data Preregistered in User Terminal and Designating Settlement Means to be Used is Transmitted to Store Terminal to Perform Settlement Processing

Next, as a fifth embodiment, an embodiment will be described in which a piece of utterance data selected by a user from a plurality of pieces of utterance data preregistered in a user terminal and designating a settlement means is transmitted to a store terminal to perform settlement processing.

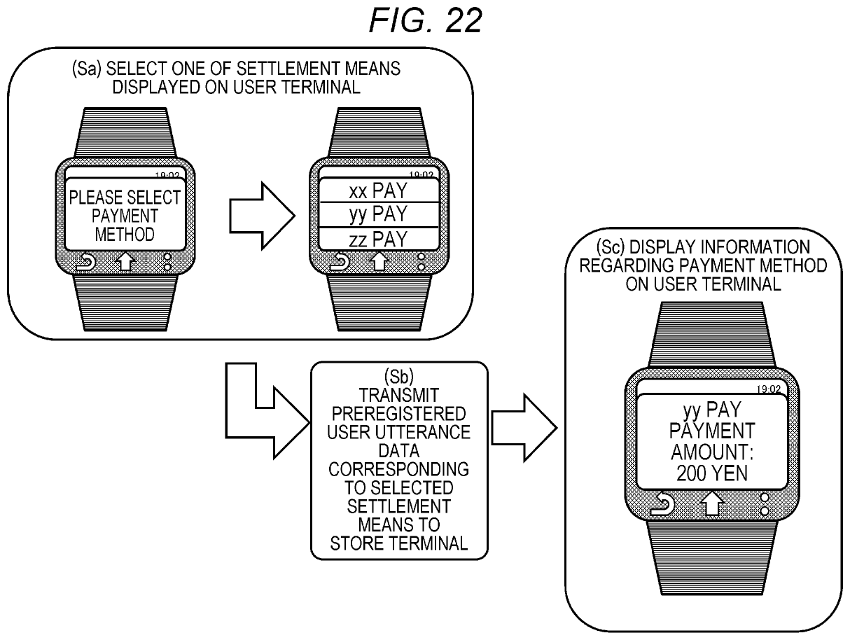

FIG. 22 is a diagram for describing an outline of processing of the fifth embodiment.

First, at the start of the settlement processing, display data illustrated in FIG. 20(Sa) is displayed on a user terminal 100.

Note that, similarly to FIG. 19, FIG. 22 also illustrates examples of a smartphone and a smartwatch side by side as examples of the user terminal 100.

The display data illustrated in FIG. 22 (step Sa) is an example of display data for requesting the user to select a payment method (settlement means) to be used.

The user recognizes the display data, and selects “yy pay” as the settlement means, for example.

Note that each of the settlement means displayed on the user terminal here is a settlement means designated by user utterance voice data preregistered in the user terminal.

Next, in (step Sb), a data processing unit of the user terminal 100 acquires, from a storage unit, preregistered user utterance data “with yy pay” corresponding to “yy pay” selected by the user, and transmits the user utterance data to a store terminal 200.

Thereafter, payment amount information is transmitted from the store terminal to the user terminal, and settlement information illustrated in FIG. 22(c) is displayed on the user terminal.

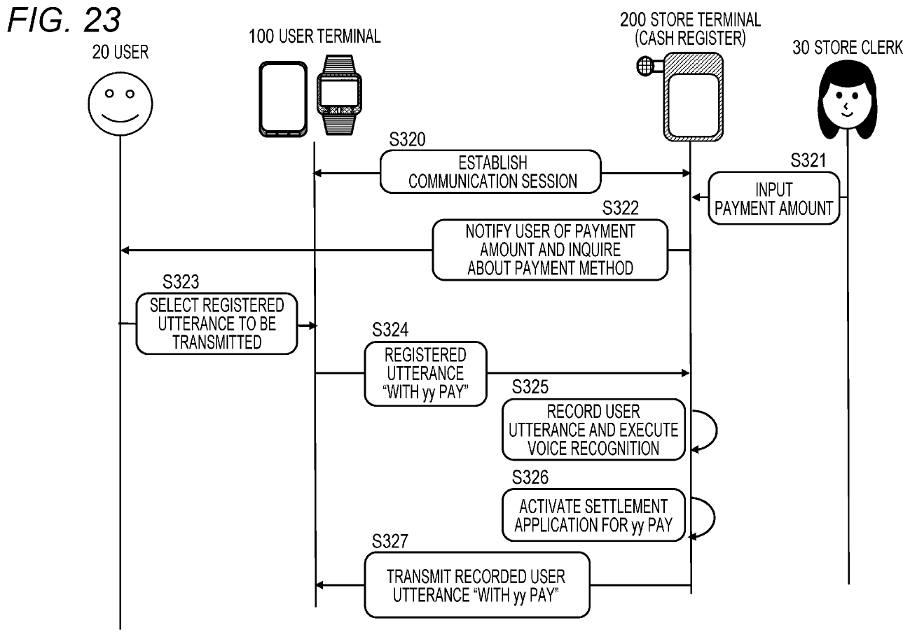

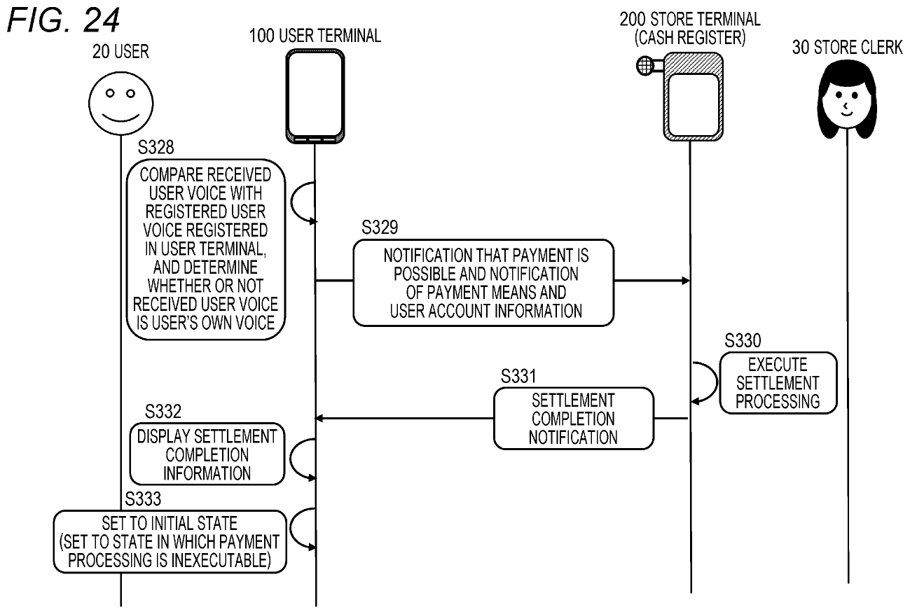

A specific sequence of the fourth embodiment will be described with reference to FIGS. 23 and 24.

FIGS. 23 and 24 illustrate, from the left, a user 20, the user terminal 100 owned by the user 20, the store terminal 200, and a store clerk 30 of a store where the store terminal 200 is placed.

The processing is performed in the order of steps S320 to S333 illustrated in FIGS. 23 and 24.

Hereinafter, processing of each step will be sequentially described.

(Step S320)

First, in step S320, a communication session is established between the store terminal 200 and the user terminal 100. That is, when the user terminal 100 approaches the store terminal 200 and reaches a position where short-range wireless communication is possible, the communication session is established between the two terminals, and the two terminals are set to a communicable state.

Note that, as described above, the short-range wireless communication executed between the store terminal 200 and the user terminal 100 is, for example, short-range wireless communication such as Bluetooth (registered trademark) (BT) communication, near field communication (NFC) communication, radio frequency (RF) communication, or ultra wide band (UWB) communication.

(Step S321)

Next, the store clerk inputs a payment amount to the store terminal 200.

Note that, here, the description will be made assuming that the store clerk 30 executes the input of the payment amount, but for example, processing may be performed in which the user 20 causes a scanner connected to the store terminal 200 to read a tag of a product. Furthermore, the settlement amount may be automatically calculated by the store terminal 200 receiving data transmitted from an RFID tag attached to the product.

(Step S322)

Next, the store terminal 200 notifies the user 20 of the payment amount, and inquires of the user 20 about the payment method (settlement means). That is, a question is asked.

(Step S323)

Next, in step S323, the user 20 selects the payment means on the user terminal 100.

Note that when the communication session is established in step S300, a settlement application is activated in the user terminal 100, and the screen illustrated above in FIG. 22 (step Sa) is displayed.

Alternatively, the user may activate the settlement application to display the screen illustrated in FIG. 22 (step Sa).

In step S323, the user 20 selects one from the plurality of payment means displayed on the user terminal 100. For example, “yy pay” is selected.

(Step S324)

Next, in step S324, the data processing unit of the user terminal 100 acquires, from the storage unit, the preregistered user utterance data “with yy pay” corresponding to “yy pay” selected by the user, and transmits the user utterance data to the store terminal 200.

(Step S325)

Next, in step S325, the store terminal 200 records the user utterance “with yy pay” received from the user terminal 100 in a storage unit, and further executes voice recognition.

With this voice recognition, it is confirmed that the user 20 requests settlement using [yy pay].

(Step S326)

Next, in step S326, the store terminal 200 activates a settlement application (application program) for performing the settlement means requested by the user 20.

(Step S327)

Next, in step S327, the store terminal 200 transmits the voice data of the user utterance “with yy pay”, which is recorded in the storage unit in step S325, to the user terminal 100 by using short-range wireless communication.

(Step S328)

Next, in step S328, the user terminal 100 compares the voice data of the user utterance “with yy pay”, which is received from the store terminal 200 in step S327, with the voice data of the user utterance “with yy pay”, which is registered in advance in the user terminal 100, and determines whether or not the pieces of voice data match each other.

Note that, in the determination as to whether or not the pieces of voice data match each other, it is determined that the pieces of voice data match each other not only in the case of exact matching but also in a case where a difference falls within a predetermined error range.

(Step S329)

In a case where, in step S328, the user terminal 100 determines that the user utterance “with yy pay” received from the store terminal 200 and the registered user utterance “with yyx pay” registered in the user terminal 100 match each other, the user terminal 100 notifies the store terminal 200 that the payment is possible in step S329.

This notification also includes the payment means (settlement means) and information necessary for the settlement processing, for example, user account information.

Note that the transmitted information is different information depending on the settlement means to be used by the user 20.

(Step S330)

Next, in step S330, the store terminal 200 executes the settlement processing according to the user account information received from the user terminal 100.

(Step S331)

Next, in step S331, the store terminal 200 transmits a settlement completion notification to the user terminal 100.

(Step S332)

Next, in step S332, the user terminal 100 displays the settlement completion notification received from the store terminal 200.

For example, data as illustrated in FIG. 7 described above is displayed.

(Step S333)

Next, in step S333, the user terminal 100 sets the user terminal 100 to an initial state. That is, the user terminal 100 is set to a state in which payment processing is inexecutable.

Through the series of processing, the store terminal 200 can confirm that the settlement means that the user 20 intends to execute by use of the user terminal 100 is “yy pay”, and perform the settlement processing to which the confirmed settlement means “yy pay” is applied.

As understood from the above description, in the present embodiment, a new user utterance is not made, and identity confirmation using only the user utterance preregistered in the user terminal is executed. Performing the child processing makes it possible to perform the settlement processing using the preregistered utterance data, for example, even in a case where it is difficult to speak due to a cold.

### 7. (Sixth Embodiment) Embodiment in which Face Authentication Based on Captured Image of User is Executed

Next, as a sixth embodiment, an embodiment will be described in which a face image of a user is captured and face authentication based on the captured image is executed.

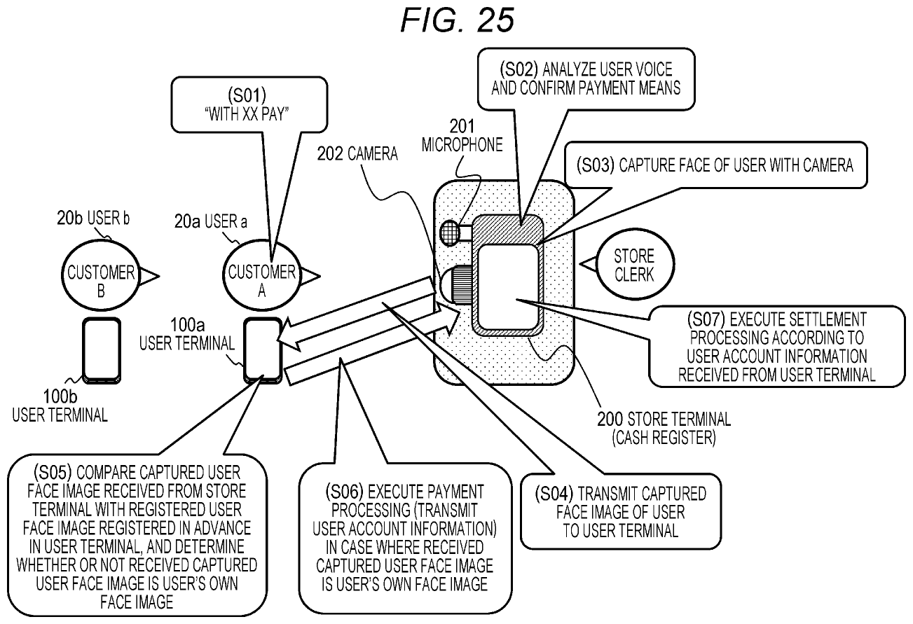

FIG. 25 is a diagram for describing exemplary processing of the sixth embodiment.

A store terminal (cash register) 200 includes a camera 202 for capturing an image in addition to a microphone 201.

In FIG. 25, the store terminal 200 is placed in front of a store clerk, and a user a (customer A) 20a as a user who makes settlement stands in front of the store terminal 200.

The user a, 20a holds a user terminal 100a such as a smartphone.

Short-range wireless communication is performed between the store terminal 200 and the user terminal 100a, and settlement processing is executed.

Note that the short-range wireless communication executed between the store terminal 200 and the user terminal 100a is, for example, short-range wireless communication such as Bluetooth (registered trademark) (BT) communication, near field communication (NFC) communication, radio frequency (RF) communication, or ultra wide band (UWB) communication.

The settlement processing by the store terminal 200 of the present disclosure is performed in the order of steps S01 to S07 illustrated in FIG. 25. Hereinafter, processing of each step will be described.

(Step S01)

First, the user a, 20a utters a settlement means.

As an example, it is assumed that the user a, 20a utters “with XX pay”.

(Step S02)

The store terminal 200 inputs the utterance of the user a, 20a “with XX pay” via the microphone 201, and in step S02, a data processing unit in the store terminal 200 executes voice analysis of the input utterance and determines that the user who intends to perform the settlement processing, that is, the user a, 20a wants to use [XX pay] as the settlement means.

(Step S03)

Next, in step S03, the store terminal 200 captures a face image of the user a, 20a by using the camera 202.

(Step S04)

Next, in step S04, the store terminal 200 transmits the face image of the user a, 20a to the user terminal 100a by using short-range wireless communication.

(Step S05)

Next, in step S05, the user terminal 100a compares the captured user face image received from the store terminal 200 with a registered user face image registered in advance in the user terminal 100a, and determines whether or not the person of the captured user face image received from the store terminal 200 is the same person as the person of the face image of the user a, 20a who is an owner of the user terminal 100a.

In a case where the captured user face image received from the store terminal 200 and the registered user face image have high similarity and can be determined to show the same person, it is determined that the person of the captured user face image received from the store terminal 200 is the person of the face image of the user a, 20a who is the owner of the user terminal 100a.

In this case, processing in and after step S06 is executed.

On the other hand, in a case where it cannot be determined that the person of the captured user face image received from the store terminal 200 is the same person as the person of the face image of the user a, 20a who is the owner of the user terminal 100a, the user terminal 100a notifies the store terminal 200 of an error. In this case, the settlement processing is not executed.

However, a configuration may be adopted in which confirmation processing of an intention to make payment for the user a, 20a is performed after the error notification, and the settlement processing is performed in a case where the intention is confirmed.

(Step S06)

In a case where it is determined in step S05 that the person of the captured user face image received from the store terminal 200 is the same person as the person of the face image of the user a, 20a who is the owner of the user terminal 100a, the processing in and after step S06 is executed.

In this case, the user terminal 100a executes the payment processing in step S06. Specifically, account information or the like of the user a, 20a, which is necessary for the settlement processing, is transmitted to the store terminal 200.

Note that the transmitted information is different information depending on the settlement means to be used by the user a, 20a.

(Step S07)

Next, in step S07, the store terminal 200 executes the settlement processing according to the user account information received from the user terminal 100a.

The present embodiment is configured to perform processing of confirming whether or not the user a, 20a who intends to execute the settlement processing is the true owner of the user terminal 100a to be used for the settlement processing by using the face image registered in advance in the user terminal 100a.

With this configuration, for example, even if another user other than the user a, 20a tries to take out and use the user terminal 100a, settlement cannot be made, and unauthorized use of the terminal can be prevented.

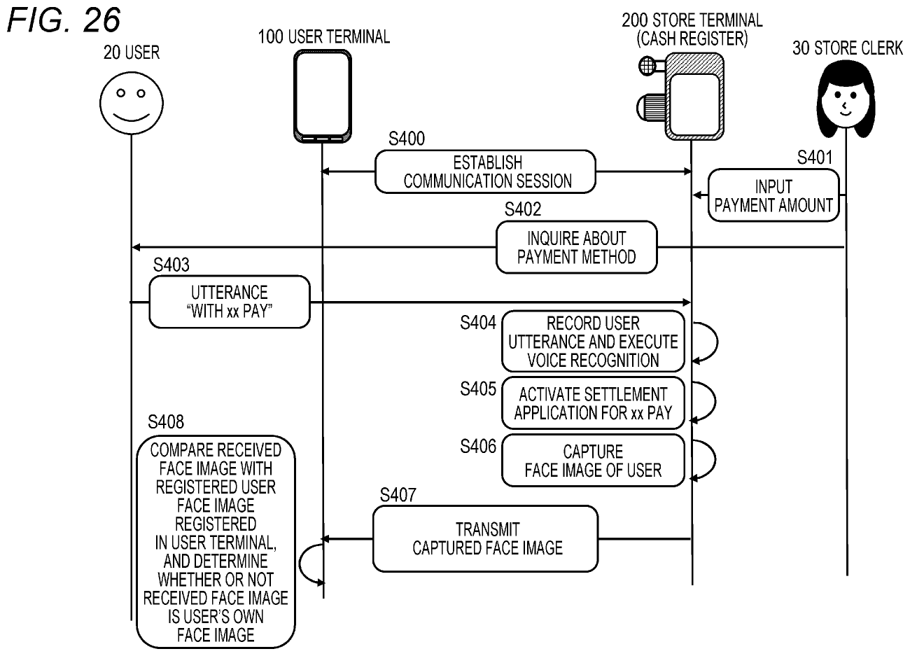

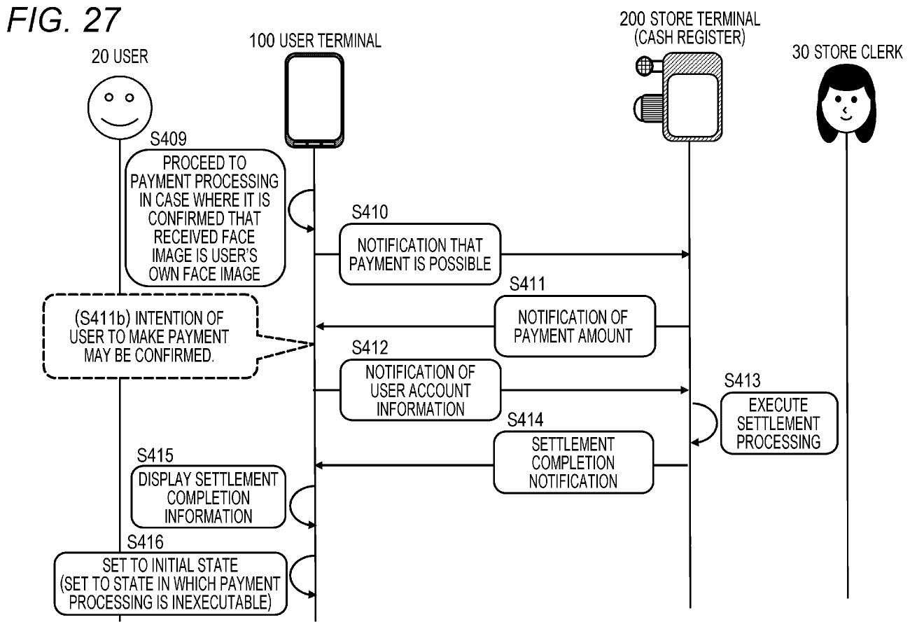

Next, a processing sequence of the sixth embodiment will be described with reference to FIGS. 26 and 27.

FIGS. 26 and 27 illustrate, from the left, a user 20, a user terminal 100 owned by the user 20, the store terminal 200, and a store clerk 30 of a store where the store terminal 200 is placed.

The processing is performed in the order of steps S400 to S416 illustrated in FIGS. 26 and 27.

Hereinafter, processing of each step will be sequentially described.

(Step S400)

First, in step S400, a communication session is established between the store terminal 200 and the user terminal 100. That is, when the user terminal 100 approaches the store terminal 200 and reaches a position where short-range wireless communication is possible, the communication session is established between the two terminals, and the two terminals are set to a communicable state.

Note that, as described above, the short-range wireless communication executed between the store terminal 200 and the user terminal 100 is, for example, short-range wireless communication such as Bluetooth (registered trademark) (BT) communication, near field communication (NFC) communication, radio frequency (RF) communication, or ultra wide band (UWB) communication.

(Step S401)

Next, the store clerk inputs a payment amount to the store terminal 200.

Note that, here, the description will be made assuming that the store clerk 30 executes the input of the payment amount, but for example, processing may be performed in which the user 20 causes a scanner connected to the store terminal 200 to read a tag of a product. Furthermore, the settlement amount may be automatically calculated by the store terminal 200 receiving data transmitted from an RFID tag attached to the product.

(Step S402)

Next, the store clerk 30 inquires of the user 20 about a payment method (settlement means). That is, a question is asked.

Note that the inquiry about the payment means may also be made by use of a voice output from the store terminal 200.

(Step S403)

Next, in step S103, the user 20 makes an utterance indicating the payment means. For example, the user 20 utters “with xx pay”. The user 20 makes the same utterance as that in collation data registered in the user terminal 100.

(Step S404)

Next, in step S404, the store terminal 200 records, in a storage unit, the user utterance “with xx pay” input via the microphone, and further executes voice recognition.

With this voice recognition, it is confirmed that the user 20 requests settlement using [xx pay].

(Step S405)

Next, in step S405, the store terminal 200 activates a settlement application (application program) for performing the settlement means requested by the user.

(Step S406)

Next, in step S406, the store terminal 200 captures a face image of the user 20 by using the camera 202.

(Step S407)

Next, in step S407, the store terminal 200 transmits the face image of the user to the user terminal 100 by using short-range wireless communication.

(Step S408)

Next, in step S408, the user terminal 100 compares the captured user face image received from the store terminal 200 with a registered user face image registered in advance in the user terminal 100, and determines whether or not the person of the captured user face image received from the store terminal 200 is the same person as the person of the face image of the user 20 who is an owner of the user terminal 100.

In a case where the captured user face image received from the store terminal 200 and the registered user face image have high similarity and can be determined to show the same person, it is determined that the person of the captured user face image received from the store terminal 200 is the person of the face image of the user 20 who is the owner of the user terminal 100.

In this case, processing in and after step S409 is executed.

On the other hand, in a case where it cannot be determined that the person of the captured user face image received from the store terminal 200 is the same person as the person of the face image of the user 20 who is the owner of the user terminal 100, the user terminal 100 notifies the store terminal 200 of an error. In this case, the settlement processing is not executed.

However, a configuration may be adopted in which confirmation processing of an intention to make payment for the user 20 is performed after the error notification, and the settlement processing is performed in a case where the intention is confirmed.

(Step S409)

In a case where it is determined in step S408 that the person of the captured user face image received from the store terminal 200 is the same person as the person of the face image of the user 20 who is the owner of the user terminal 100, the processing proceeds to the payment processing in step S409.

(Step S410)

In step S410, the user terminal 100 notifies the store terminal 200 that the payment is possible.

(Step S411)

Next, in step S411, the store terminal 200 notifies the user terminal 100 of the payment amount.

Note that, at this point, as processing of (step S411b), processing of requesting the user 20 to confirm the intention to make payment may be performed.

Specifically, when the user terminal 100 is notified of the payment amount in step S411, for example, display data as described above with reference to FIG. 6 is transmitted from the store terminal 200 to the user terminal 100 and displayed on the user terminal 100.

(Step S412)

Next, in step S412, the user terminal 100 transmits account information or the like of the user 20, which is necessary for the settlement processing, to the store terminal 200.

Note that the transmitted information is different information depending on the settlement means to be used by the user 20.

(Step S413)

Next, in step S413, the store terminal 200 executes the settlement processing according to the user account information received from the user terminal 100.

(Step S414)

Next, in step S414, the store terminal 200 transmits a settlement completion notification to the user terminal 100.

(Step S415)

Next, in step S415, the user terminal 100 displays the settlement completion notification received from the store terminal 200.

For example, data as described above with reference to FIG. 7 is displayed.

(Step S416)

Next, in step S416, the user terminal 100 sets the user terminal 100 to an initial state. That is, the user terminal 100 is set to a state in which payment processing is inexecutable.

The present embodiment is configured to perform processing of confirming the settlement means on the basis of the user utterance of the user 20 who intends to execute the settlement processing, and further confirming whether or not the user 20 is the true owner of the user terminal 100a to be used for the settlement processing by using the face image registered in advance in the user terminal 100a.

With this configuration, it is possible to reliably confirm the settlement means and confirm the true owner of the user terminal, and it is possible to prevent erroneous settlement processing and unauthorized settlement.

### 8. (Seventh Embodiment) Embodiment in which User or User Terminal that Makes Settlement is Specified on the Basis of Captured Images of User (Customer) Moving in Store and Information Received from User Terminal

Next, as a seventh embodiment, an embodiment will be described in which a user or a user terminal that makes settlement is specified on the basis of captured images of the user (customer) moving in a store and information received from the user terminal.

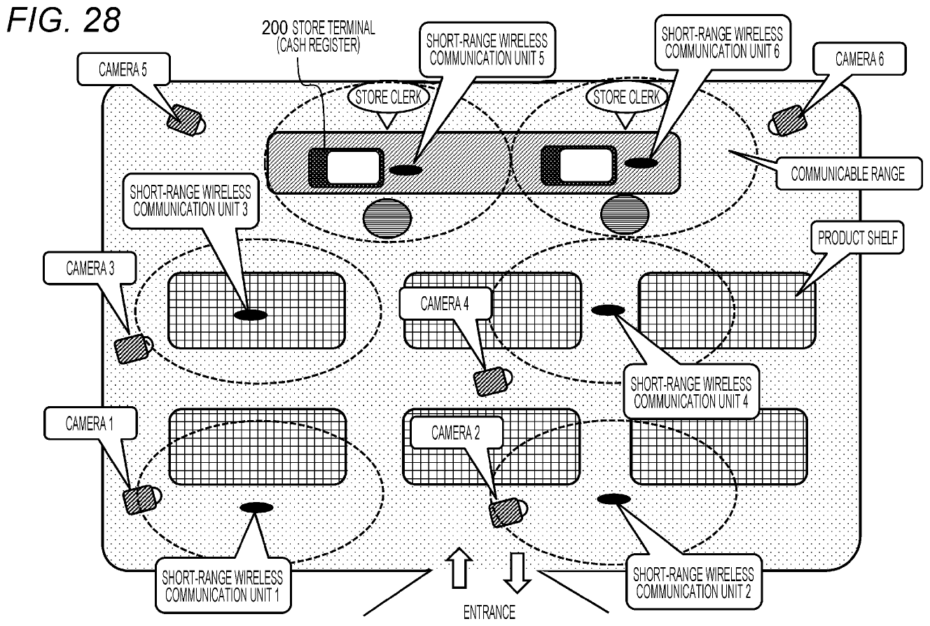

The present embodiment will be described with reference to FIG. 28 and subsequent drawings.

FIG. 28 illustrates one store. A central lower part of FIG. 28 is a store entrance, and users (customers) enter and exit the store.

In an upper part of FIG. 28, there is a store clerk, and a store terminal (cash register) 200 is placed in front of the store clerk. The store terminal 200 performs short-range wireless communication with a user terminal of a user (customer) to perform settlement processing.

A large number of users (customers) visit the store and perform settlement processing. In the present embodiment, the store terminal 200 is connected by wire or wirelessly to cameras and short-range wireless communication units provided at a plurality of places in the store.

The store terminal 200 inputs images captured by the cameras provided at the plurality of places in the store. Moreover, the store terminal 200 inputs information transmitted to and received from user terminals of the users (customers) by the short-range wireless communication units provided at the plurality of places in the store.

The store terminal 200 analyzes the images captured by the cameras and the communication information of the short-range wireless communication units, and generates correspondence data between the users (customers) and the user terminals.

Specifically, user attribute information such as gender, age, clothes, and belongings of the users (customers) is analyzed on the basis of the camera-captured images.

Moreover, identification information (user terminal IDs) of the user terminals is acquired on the basis of the information transmitted and received between the short-range wireless communication units and the user terminals of the users (customers).

Finally, correspondence data between the user attribute information of the users and the identification information (user terminal IDs) of the user terminals (user attribute/user terminal correspondence data) is generated.

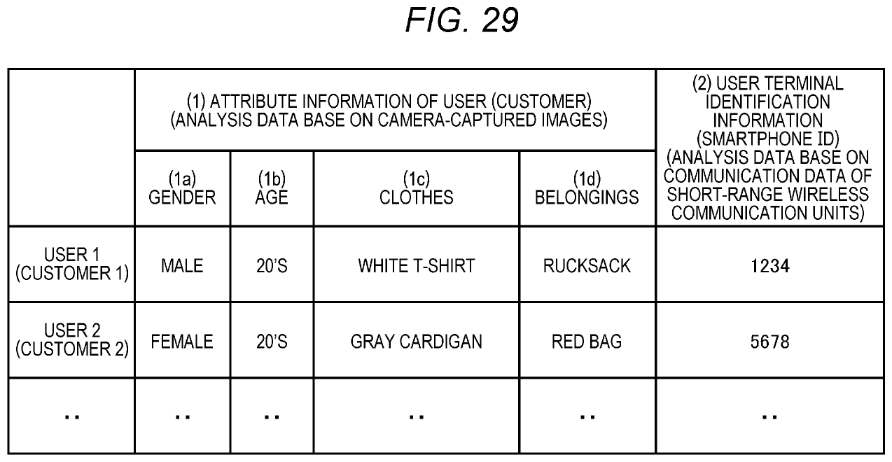

A specific example of the generated data is illustrated in FIG. 29.

The data illustrated in FIG. 29 is correspondence data (user attribute/user terminal correspondence data) in which user attribute information (gender, age, clothes, and belongings) in a unit of a user (customer) in the store, who is captured by the camera, is associated with an identifier (for example, a smartphone ID) of a user terminal owned by the user.

The store terminal 200 generates the correspondence data (user attribute/user terminal correspondence data) on the basis of the camera-captured images and the communication data of the short-range wireless communication units and stores the correspondence data in a storage unit.

For example, in a case where a certain user (customer) moves in front of the store terminal 200 and tries to make settlement, the store terminal 200 acquires user attributes (gender, age, clothes, and belongings) from an image captured by a camera that captures an image in front of the store terminal 200, for example, a camera 5 illustrated in FIG. 28.

Next, the store terminal 200 selects an entry having user attributes matching the acquired user attributes from the correspondence data (user attribute/user terminal correspondence data) stored in the storage unit.

Moreover, user terminal identification information (smartphone ID) recorded in the selected entry is acquired.

Through the series of processing, the user terminal of the user who performs the settlement processing is specified, and the store terminal 200 communicates with the specified user terminal so that it is possible to execute the settlement processing.

Note that processing of generating the correspondence data (user attribute/user terminal correspondence data), processing of recording the correspondence data in the storage unit, processing of analyzing the user attributes based on the captured image near the store terminal 200, processing of searching the correspondence data based on the analysis result, and the like may be executed by an external server other than the store terminal 200.

The external server has a configuration capable of communicating with the store terminal and the cameras and the short-range wireless communication units in the store, acquires and analyzes the camera-captured images and the data transmitted to and received from the short-range wireless communication units, generates the correspondence data (user attribute/user terminal correspondence data), and stores the generated correspondence data in a storage unit in the server. Furthermore, the external server may be configured to execute the processing of analyzing the user attributes based on the captured image near the store terminal 200 and the processing of searching the correspondence data based on the analysis result, and notify the store terminal 200 of the user terminal identification information obtained from the search result.

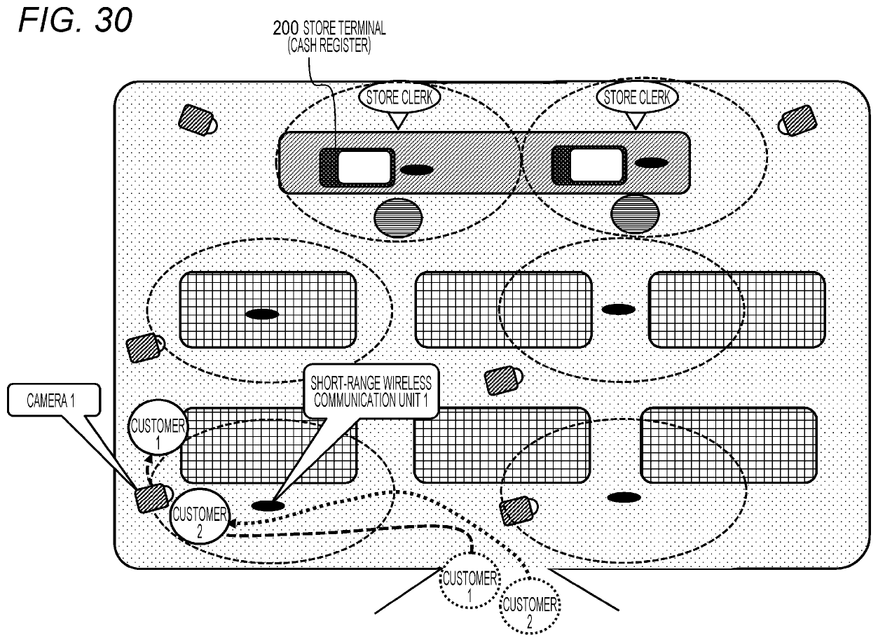

A specific processing sequence of the present embodiment will be described with reference to FIG. 30 and subsequent drawings.

FIG. 30 illustrates a state in which two customers 1 and 2 enter the store and pass through an image capturing area of a camera 1 and a communicable area of a short-range wireless communication unit 1.

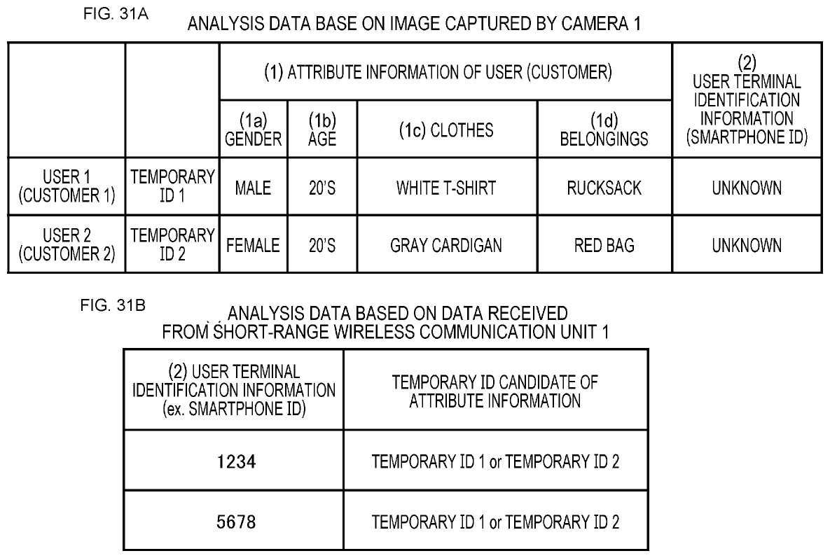

In this state, analysis data illustrated in FIG. 31 is generated on the basis of an image captured by the camera 1 and communication information of the short-range wireless communication unit 1.

Note that the analysis data illustrated in FIG. 31 is generated in the store terminal 200 or the external server.

FIG. 31(1) illustrates analysis data generated on the basis of the image captured by the camera 1.

User attributes (gender, age, clothes, and belongings) of each of the user 1 (customer 1) and the user 2 (customer 2) are recorded in the storage unit as analysis data. The storage unit is a storage unit in the store terminal or in the external server.

Since the analysis data in FIG. 31(1) is analysis data generated on the basis of the image captured by the camera 1, the user terminal identification information remains unknown.

FIG. 31(2) illustrates analysis data generated on the basis of the communication information of the short-range wireless communication unit 1.

The short-range wireless communication unit 1 can communicate with a user terminal 1 of the user 1 (customer 1) and a user terminal 2 of the user 2 (customer 2) and analyze the terminal identification information of the two user terminals. However, the short-range wireless communication unit 1 cannot perform analysis to determine which of the terminal of the user 1 (customer 1) and the terminal of the user 2 (customer 2) each of the two user terminals is.

That is, at this point, the analysis data generated on the basis of the image captured by the camera 1, which is illustrated in FIG. 31(1), and the analysis data generated on the basis of the communication information of the short-range wireless communication unit 1, which is illustrated in FIG. 31(2), are individually generated, and entries of these two pieces of analysis data are not associated with each other.

A temporary ID 1 and a temporary ID 2 are set to two entries of the analysis data generated on the basis of the image captured by the camera 1, which is illustrated in FIG. 31(1), and it is confirmed that both two entries of the analysis data generated on the basis of the communication information of the short-range wireless communication unit 1, which is illustrated in FIG. 31(2), each correspond to either the temporary ID 1 or the temporary ID 2.

That is, analysis to determine which of the terminal of the user 1 (customer 1) and the terminal of the user 2 (customer 2) is indicated by the identification information (1234 or S678) of each of the two user terminals illustrated in FIG. 31(2) cannot be performed in this state.

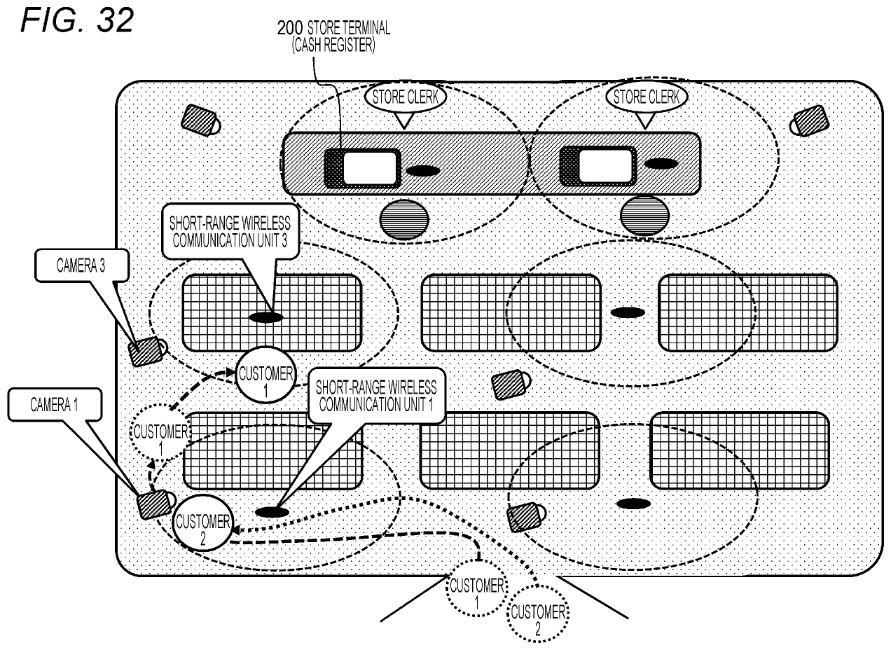

Next, the user 1 (customer 1) and the user 2 (customer 2) walk in the store and move to the positions illustrated in FIG. 32.

The state illustrated in FIG. 32 is a state in which the user 1 (customer 1) is captured by a camera 3 and a short-range wireless communication unit 3 can communicate with the user terminal 1 owned by the user 1 (customer 1).

The user 2 (customer 2) is captured by the camera 1, and the short-range wireless communication unit 1 can communicate with the user terminal 2 owned by the user 2 (customer 2).

In this state, the user attributes (gender, age, clothes, and belongings) obtained from the image captured by the camera 3 and the identifier (smartphone ID) of the user terminal analyzed from the communication information of the short-range wireless communication unit 3 can be associated on a one-to-one basis.

Similarly, the user attributes (gender, age, clothes, and belongings) obtained from the image captured by the camera 1 and the identifier (smartphone ID) of the user terminal analyzed from the communication information of the short-range wireless communication unit 1 can also be associated on a one-to-one basis.

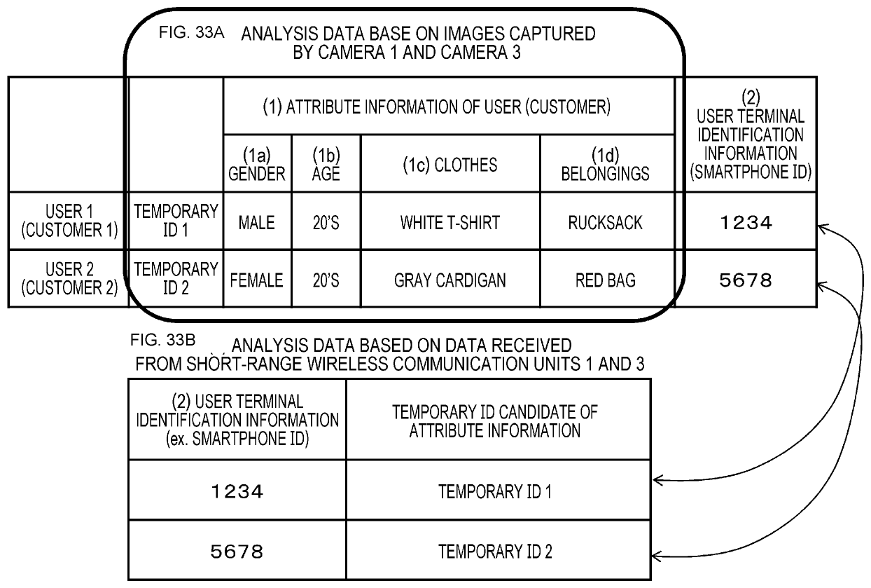

As a result, as illustrated in FIG. 33, two entries included in (1) the analysis data generated on the basis of the images captured by the camera 1 and the camera 3 and two entries included in (2) the analysis data generated on the basis of the communication information of the short-range wireless communication units 1 and 3 can be individually associated with each other.

As a result, each entry of (1) the analysis data generated on the basis of the images captured by the camera 1 and the camera 3, which is illustrated in FIG. 33, can record a corresponding one of the user terminal identifiers recorded in (2) the analysis data generated on the basis of the communication information of the short-range wireless communication units 1 and 3, so that the user attribute/user terminal correspondence data is completed.

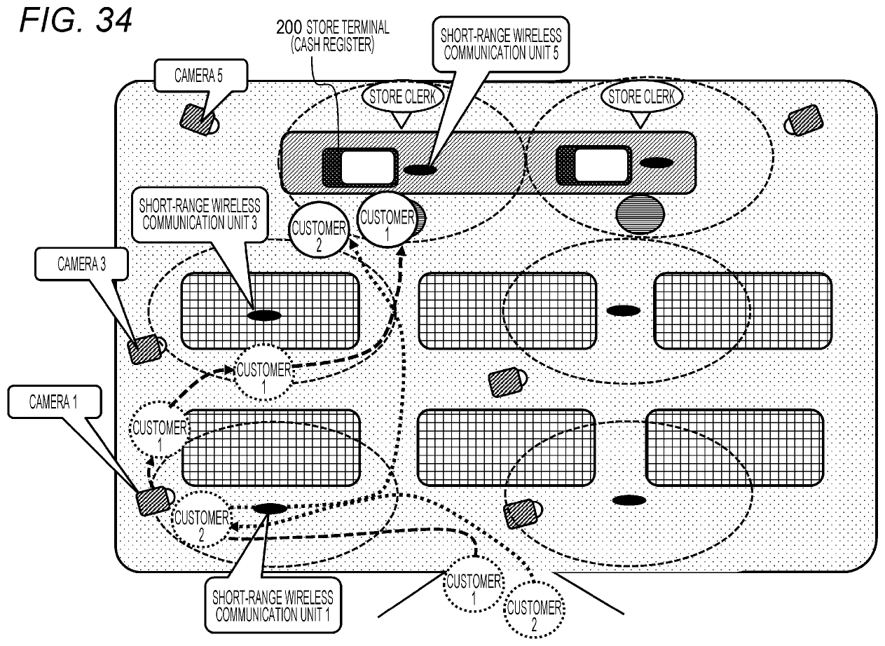

FIG. 34 illustrates a state in which the user 1 (customer 1) stands in front of the store terminal 200 and intends to perform payment processing.

However, the user 2 (customer 2) is also nearby, and the store terminal 200 can communicate with two user terminals of the user terminal 1 of the user 1 (customer 1) and the user terminal 2 of the user 2 (customer 2).

At this time, the store terminal 200 or the external server analyzes an image of the camera 5 that captures an image in front of the store terminal 200. Through this image analysis, it is determined that the user standing in front of the store terminal 200 and intending to perform the payment processing is the user 1 (customer 1).

Moreover, the identifier of the user terminal 1 of the user (customer 1) is acquired from the previously generated user attribute/user terminal correspondence data.

The store terminal 200 acquires the identifier of the user terminal 1 in communication with the user terminal 1 of the user (customer 1), and acquires the identifier of the user terminal 2 in communication with the user terminal 2 of the user 2 (customer 2).

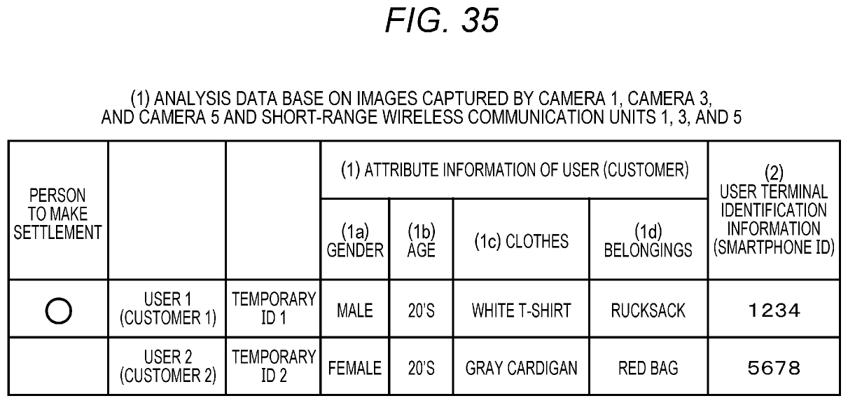

Currently, it is found that the user standing in front of the store terminal 200 and intending to perform the payment processing is the user 1 (customer 1). On the basis of this result, it is possible to determine that the user 1 (customer 1) among the two users is the person to make the settlement as illustrated in FIG. 35.

On the basis of this result, the store terminal 200 continues the communication with the user terminal 1 of the user (customer 1) from among the two user terminals in the communication state, and stops the communication with the user terminal 2 of the user 2 (customer 2).

Thereafter, the store terminal 200 communicates with the user terminal 1 of the user 1 (customer 1) continuing the communication, and executes the settlement processing.

As described above, in the present embodiment, the identifier of the user terminal held by each user is acquired on the basis of the information acquired by the plurality of cameras and the plurality of short-range wireless communication units provided in the store, and in the settlement processing of each user, the user terminal held by the user is specified, so that communication with the user terminal makes it possible to perform the settlement processing without an error.

The sixth embodiment is an embodiment in which analyzing information acquired by a plurality of cameras and a plurality of short-range wireless communication units makes it possible to specify a user terminal held by an individual user.

This processing is not limited to settlement processing in a store, and can also be applied to, for example, gate opening/closing control of a ticket gate of a station, a gate of an airport or a building, or the like.

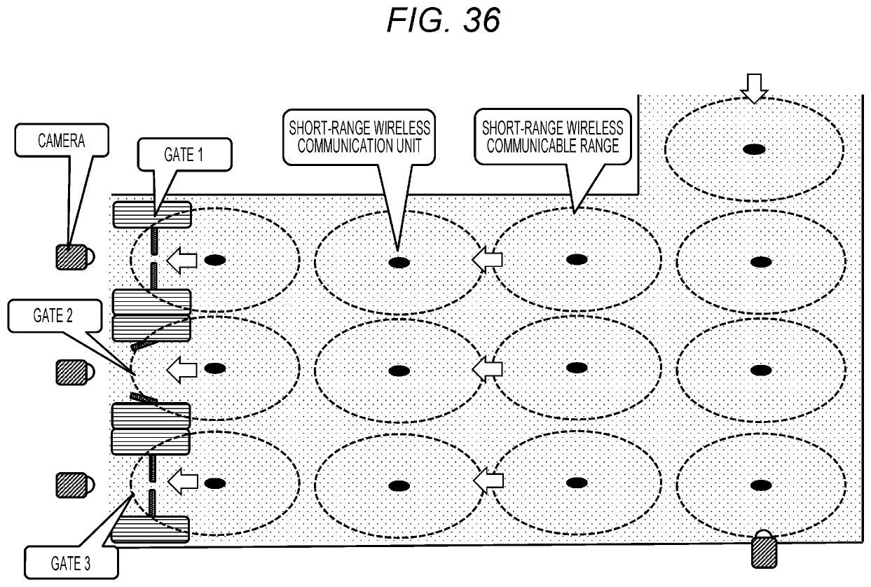

A specific example of the gate control will be described with reference to FIG. 36 and subsequent drawings. FIG. 36 illustrates gates 1 to 3. A user (customer) who intends to pass through a gate advances in the gate direction along arrows from the upper right of the drawing and passes through the gate.

A plurality of cameras and a plurality of short-range wireless communication units are provided on this passage.

The plurality of cameras captures images of the user (customer) walking on the passage. The plurality of short-range wireless communication units communicates with a user terminal such as a smartphone held by the user (customer) walking on the passage.

The camera-captured images and the communication data of the short-range wireless communication units are transmitted to a server that performs gate control processing and analyzed. On the basis of the analysis result, user attribute/user terminal correspondence data in which user attributes (gender, age, clothes, and belongings) similar to those described above with reference to FIG. 29 and the like are associated with an identifier (smartphone ID) of the user terminal is generated and stored in a storage unit.

Note that, for example, in a case where the gates are ticket gates of a station, the server holds, in addition to the above-described user attribute/user terminal correspondence data, user management data as correspondence data between a user terminal ID and commutation ticket information or balance information corresponding to the ID.

The server that performs the gate control processing performs the opening/closing control of the gates on the basis of the user management data and the user attribute/user terminal correspondence data.

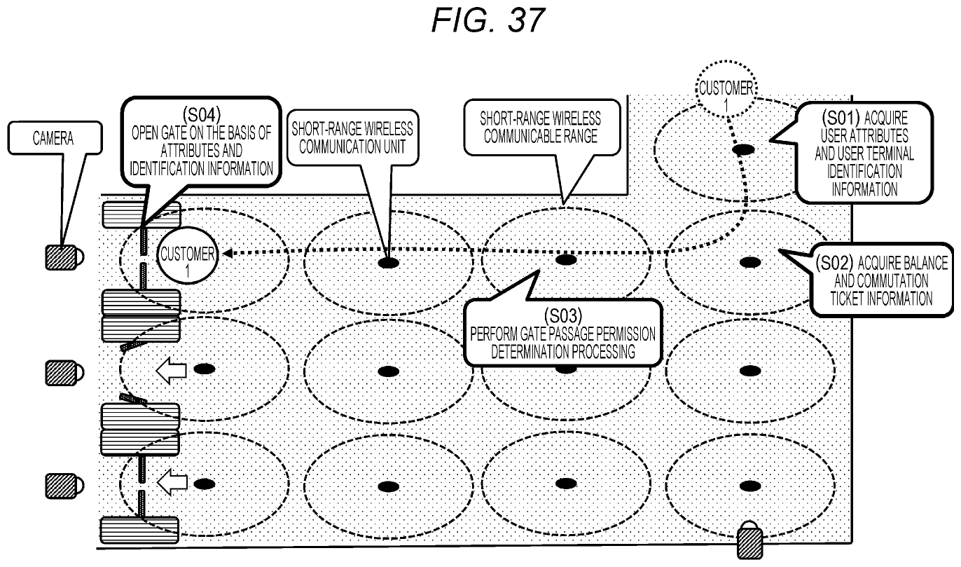

A specific example will be described with reference to FIG. 37.

It is assumed that a user 1 (customer 1) enters the station from the upper right of the passage and proceeds toward the gate 1.

Processing of (S01) to (S04) illustrated in the drawing are sequentially executed in the server.

First, in step S01, the server acquires user attribute information (gender, age, clothes, and belongings) and user terminal identification information (smartphone ID). These are acquired on the basis of the camera-captured images and the communication information of the short-range wireless communication units.

Next, in step S02, the server refers to the user management data as the correspondence data between the user terminal ID and the commutation ticket information or the balance information corresponding to the ID, and acquires the commutation ticket information or the balance information of the user 1 (customer 1).

Next, in step S03, the server determines that the user 1 (customer 1) is qualified to pass through the gate on the basis of the commutation ticket information or the balance information of the user 1 (customer 1), and performs gate passage permission determination processing.

Next, in step S04, the server confirms that the user 1 (customer 1) has approached the gate, and performs control to open the gate.

As described above, using the user attribute/user terminal correspondence data in which the user attributes (gender, age, clothes, and belongings) and the identifier (smartphone ID) of the user terminal are associated with each other makes it possible to smoothly execute the opening/closing control of the gate without an error.

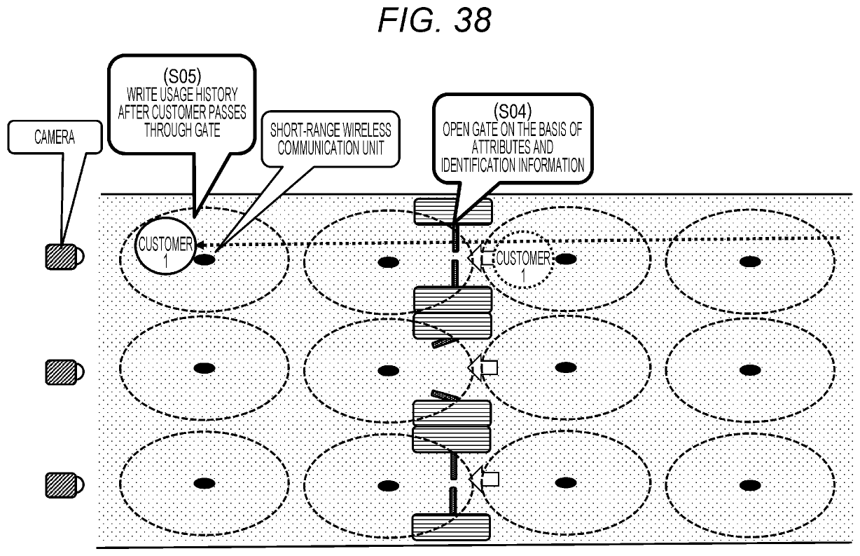

Note that, as illustrated in step S05 of FIG. 38, if a short-range wireless communication unit is installed at a position where the user 1 (customer 1) passes through after passing through the gate and is set to be communicable with the user terminal, it is also possible to perform writing processing of updating the commutation ticket information or the balance information recorded in the user terminal after the user 1 (customer 1) passes through the gate.

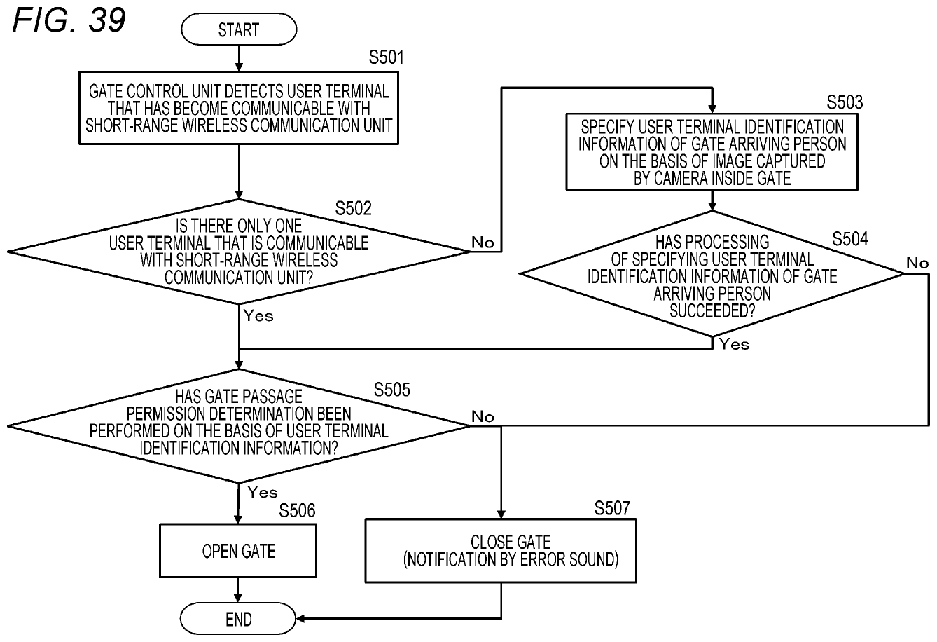

An example of a sequence of the gate control executed by the server functioning as a gate control device will be described with reference to a flowchart illustrated in FIG. 39.

Processing of each step of the flow will be sequentially described.

Note that the processing according to the flow illustrated in FIG. 39 is processing executed for each short-range wireless communication unit, and the server executes the processing according to the flow illustrated in FIG. 39 in parallel for the plurality of short-range wireless communication units.

(Step S501) First, in step S501, the server serving as the gate control device detects a user terminal that has become communicable with a certain short-range wireless communication unit.

(Step S502)

Next, in step S502, the server serving as the gate control device determines whether or not there is only one user terminal that has become communicable with the short-range wireless communication unit.

In a case where there is only one user terminal, the processing proceeds to step S505.

In a case where there is a plurality of user terminals, the processing proceeds to step S503.

(Step S503) In a case where it is determined in step S502 that there is a plurality of user terminals that has become communicable with the short-range wireless communication unit, the server serving as the gate control device executes processing of step S503.

In step S503, the server specifies user terminal identification information of a gate arriving person on the basis of an image captured by a camera inside a gate.

(Step S504)

Next, the server determines whether or not the processing of specifying the user terminal of the gate arriving person has succeeded.

In the case of success, the processing proceeds to step S505.

In the case of failure, the processing proceeds to step S507.

(Steps S505 to S507)

In a case where it is determined in step S502 that there is only one user terminal that has become communicable with the short-range wireless communication unit, or in a case where, in step S504, the processing of specifying the user terminal of the gate arriving person has succeeded, the processing of step S505 is executed.

In step 505, the server determines whether or not the user is a user permitted to pass through the gate on the basis of the user terminal identification information. This processing is executed with reference to the above-described user management data as the correspondence data between the user terminal ID and the commutation ticket information or the balance information corresponding to the ID.

In a case where it is determined that the user is a user permitted to pass through the gate, the processing proceeds to step S506, and the gate is opened to allow the user to pass through.

On the other hand, in a case where it is determined that the user is not a user permitted to pass through the gate, the processing proceeds to step S507, the gate is closed, and an error sound is output.

Note that the processing of step S507 is also executed in a case where, in step S504, the processing of specifying the user terminal of the gate arriving person has failed.

As described above, using the user attribute/user terminal correspondence data in which the user attributes (gender, age, clothes, and belongings) and the identifier (smartphone ID) of the user terminal are associated with each other makes it possible to smoothly execute the opening/closing control of the gate without an error.

Note that although the plurality of embodiments has been described so far, the plurality of embodiments may be executed individually, or any plurality of embodiments may be executed in combination.

### 9. Configuration Example of Each Device

Next, a specific device configuration example of each information processing device used in the settlement processing system of the present disclosure, that is, a user terminal 100, a store terminal 200, and a server will be described.

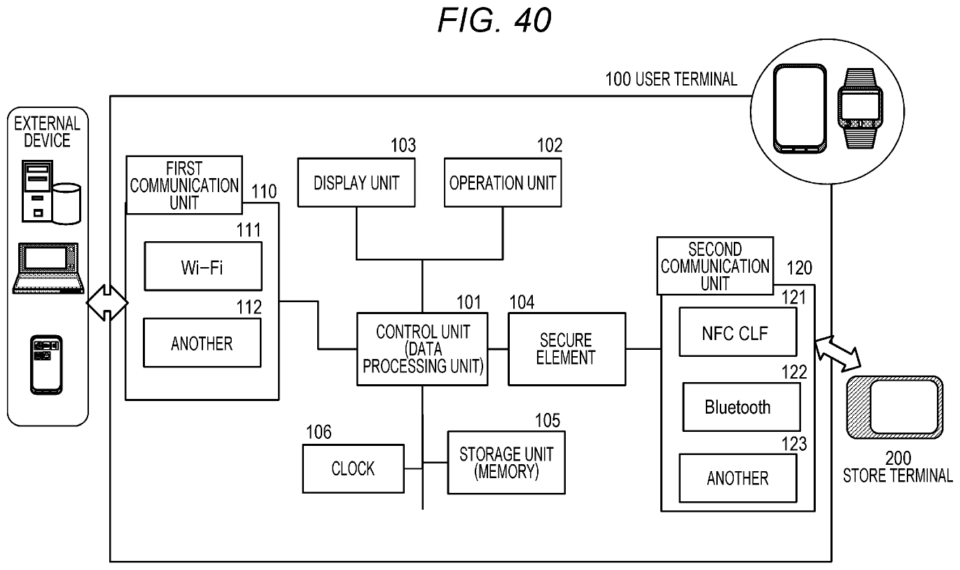

First, a device configuration example of the user terminal 100 will be described with reference to FIG. 40.

The user terminal 100 is, for example, a smartphone (smartphone), and has, for example, a configuration illustrated in FIG. 40.

As illustrated in FIG. 40, the user terminal 100 includes a control unit (data processing unit) 101, an operation unit 102, a display unit 103, a secure element 104, a storage unit (memory) 105, a clock 106, a first communication unit 110, and a second communication unit 120.

The first communication unit 110 includes a Wi-Fi communication unit 111 and another communication unit 112. The second communication unit 120 includes an NFC-CLF 121, a Bluetooth (registered trademark) communication unit 122, and another communication unit 123.

The control unit (data processing unit) 101 executes control of processing executed by the user terminal 100. Specifically, the control unit (data processing unit) 101 executes control processing of communication with a store terminal or a short-range wireless communication unit, settlement processing, user utterance collation processing, image collation processing, and the like.

Note that control programs, applications, and the like executed by the control unit (data processing unit) 101 are stored in the storage unit (memory) 105.

The control unit (data processing unit) 101 includes a processor such as a CPU having a program execution function.

The operation unit 102 is an operation unit that can be operated by a user, and includes a touch panel on the display unit 103 and the like in addition to various switches. The user can input various types of information via the operation unit 102.

The display unit 103 is a display unit such as a liquid crystal display, for example, and is used to display execution information and the like of various applications.

The secure element 104 is an IC chip configured as an element including a secure memory and a memory control unit. The secure memory in the secure element 104 stores a cashless settlement function providing application and the like.

The storage unit (memory) 105 records the control programs and applications executed by the control unit 101, ID information, user account information, and the like.

The clock 106 is clock information, and outputs the clock information to each processing unit.

The first communication unit 110 includes the Wi-Fi communication unit 111 and the another communication unit 112, and is used for communication with an external device, for example, the server, a PC, a smartphone, a wearable device, or the like. The another communication unit 112 is a communication unit having a long-distance communication function, such as a telephone line or the Internet.

The second communication unit 120 includes the NFC-CLF 121, the Bluetooth (registered trademark) communication unit 122, and the another communication unit 123, and performs communication processing with, for example, the store terminal 200 or the short-range wireless communication unit. The another communication unit 123 is a communication unit that performs short-range wireless communication, such as an RF communication unit or ultra wide band (UWB) communication.

The NFC-CLF 121 is a near field communication (NFC)-contactless front end (CLF) and is a type of IC chip for short-range communication.

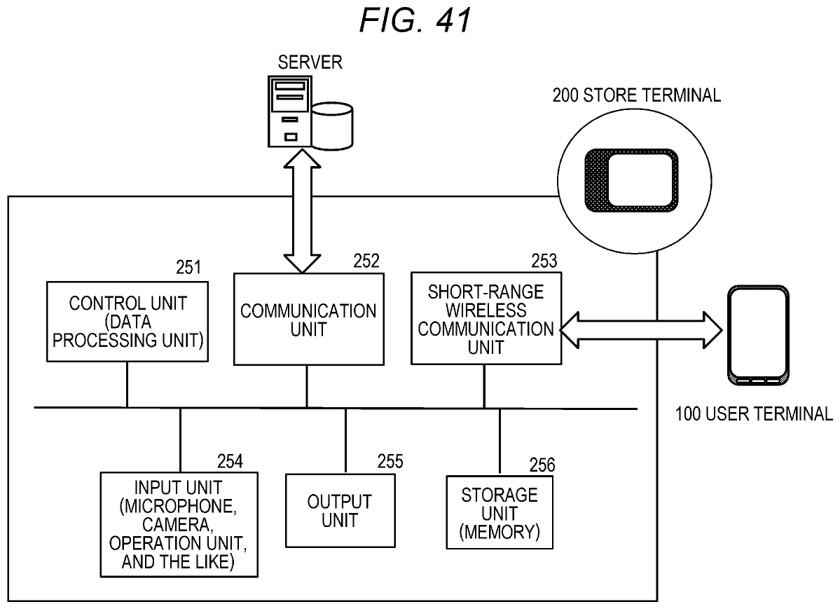

Next, a configuration example of the store terminal 200 will be described with reference to FIG. 41.

FIG. 41 is a block diagram illustrating the configuration example of the store terminal 200.

The store terminal 200 includes a control unit (data processing unit) 251, a communication unit 252, a short-range wireless communication unit 253, an input unit (microphone, camera, operation unit, and the like) 254, an output unit 255, and a storage unit (memory) 256.

The control unit (data processing unit) 251 performs overall control of processing executed by the store terminal 200.

Specifically, the control unit (data processing unit) 251 executes processing such as settlement processing and communication control. Note that execution programs for these types of processing are stored in the storage unit (memory) 255. The control unit (data processing unit) 251 includes a processor such as a CPU having a program execution function.

The communication unit 252 executes, for example, communication with an external server. The external server is, for example, various servers such as a settlement server and a user information management server.

The short-range wireless communication unit 253 is a communication unit that performs short-range wireless communication with the user terminal.

The input unit (microphone, camera, operation unit, and the like) 254 is an input unit capable of inputting an image captured by a camera attached to the outside, inputting communication data from the short-range wireless communication unit, and further inputting data and information by operation by the user, and is also used for inputting a settlement amount, for example.

The output unit 255 includes, for example, a display unit, a sound output unit, and the like, displays the settlement amount, and outputs various messages, warnings, and the like.

The storage unit (memory) 256 records the programs executed by the control unit (data processing unit) 251, parameters applied to program execution, and the like.

Moreover, the storage unit (memory) 256 is also used as an information recording area for a store terminal ID, store terminal information, the settlement amount, and the like.

Next, an example of a hardware configuration that can be used as the user terminal 100, the store terminal 200, and the server will be described.

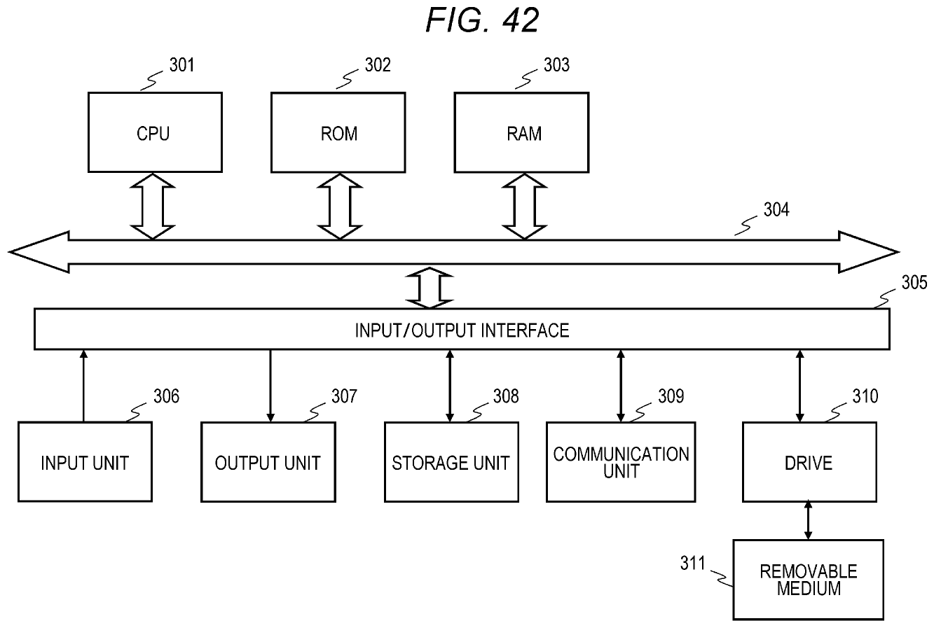

FIG. 42 is a diagram illustrating the example of the hardware configuration that can be used as the user terminal 100, the store terminal 200, and the server.

The hardware configuration illustrated in FIG. 42 will be described.

A central processing unit (CPU) 301 functions as a control unit or a data processing unit that executes various types of processing according to programs stored in a read only memory (ROM) 302 or a storage unit 308. For example, processing according to the sequences described in the above-described embodiments is executed. A random access memory (RAM) 303 stores the programs executed by the CPU 301, data, and the like. The CPU 301, the ROM 302, and the RAM 303 are mutually connected by a bus 304.

The CPU 301 is connected to an input/output interface 305 via the bus 304, and an input unit 306 including various switches, a keyboard, a mouse, a microphone, and the like, and an output unit 307 including a display, a speaker, and the like are connected to the input/output interface 305. The CPU 301 executes various types of processing in response to commands input from the input unit 306, and outputs the processing results to the output unit 307, for example.

The storage unit 308 connected to the input/output interface 305 includes, for example, a flash memory, a hard disk, and the like, and stores the programs executed by the CPU 301 and various types of data.

A communication unit 309 of each of the user terminal 100, the store terminal 200, and the server needs to have a different configuration.

The user terminal 100 and the store terminal 200 each include a communication unit capable of performing both short-range wireless communication and long-distance communication.

The server does not need a short-range wireless communication function and is only required to have a configuration capable of long-distance communication.

A drive 310 connected to the input/output interface 305 drives a removable medium 311 such as a magnetic disk, an optical disk, a magneto-optical disk, or a semiconductor memory such as a memory card, and records or reads data.

However, the store terminal 200 does not necessarily include the removable medium 311 or the drive 310 as described above.

### 10. Summary of Configuration of Present Disclosure

Hereinabove, the embodiments of the present disclosure have been described in detail with reference to specific embodiments. However, it is obvious that those skilled in the art can modify the embodiments and replace the embodiments with substitutes of the embodiments without departing from the gist of the present disclosure. That is, the present invention has been disclosed in the form of exemplification, and should not be interpreted in a limited manner. In order to determine the gist of the present disclosure, the claims should be taken into consideration.

Note that the technology disclosed in the present specification can have the following configurations.

(1) An information processing device including:

a communication unit; and

a data processing unit, in which

the data processing unit

inputs a user utterance made by a user and designating a settlement means from a store terminal via the communication unit,

determines whether or not the user utterance input from the store terminal matches a registered user utterance for collation stored in a storage unit, and

communicates with the store terminal to perform settlement processing in response to determination that the user utterance matches the registered user utterance.

(2) The information processing device according to (1), in which the storage unit stores one or more user utterances each designating a settlement means as user utterances for collation.

(3) The information processing device according to (1) or (2), in which

the data processing unit

transmits information necessary for the settlement processing to the store terminal

in a case where it is determined that the user utterance input from the store terminal matches the registered user utterance for collation stored in the storage unit.

(4) The information processing device according to any one of (1) to (3), in which

the data processing unit

sends an error notification to the store terminal

in a case where it is not determined that the user utterance input from the store terminal matches the registered user utterance for collation stored in the storage unit.

(5) The information processing device according to any one of (1) to (4), in which

the data processing unit

displays user intention confirmation data on a display unit in a case where an inquiry for confirming an intention of the user to execute the settlement processing is received from the store terminal, and

transmits a notification indicating that the user has the intention to execute the settlement processing to the store terminal in a case where the user makes an input indicating the intention to execute the settlement processing.

(6) The information processing device according to any one of (1) to (5), in which

the data processing unit

inputs the user utterance made by the user and designating the settlement means via a microphone,

determines whether or not the user utterance input via the microphone matches the registered user utterance for collation stored in the storage unit, and

communicates with the store terminal to perform the settlement processing in response to determination that the user utterance matches the registered user utterance.

(7) The information processing device according to any one of (1) to (6), in which

the data processing unit

inputs information regarding a settlement means selected by the user from a plurality of settlement means displayed on a display unit,

selects a user utterance designating the settlement means selected by the user from registered user utterances stored in the storage unit, and transmits the selected user utterance to the store terminal.

(8) The information processing device according to any one of (1) to (7), in which

the data processing unit

inputs, from the store terminal that captures a user image with a camera, the user image via the communication unit,

determines whether or not a person of the user image input from the store terminal matches a person of a registered user image for collation stored in the storage unit, and

communicates with the store terminal to perform the settlement processing in response to determination that the person of the user image matches the person of the registered user image.

(9) An information processing device including:

a microphone;

a communication unit that communicates with a user terminal; and

a data processing unit, in which

the data processing unit

inputs a user utterance made by a user and designating a settlement means via the microphone, executes voice recognition processing to determine the settlement means designated by the user,

transmits the user utterance to the user terminal via the communication unit, and

executes settlement processing in response to a payment execution notification received from the user terminal when authentication based on the user utterance is established in the user terminal.

(10) The information processing device according to (9), in which

the payment execution notification from the user terminal

is a notification transmitted to the information processing device in a case where the user terminal determines whether or not the user utterance received from the information processing device matches a registered user utterance preregistered in a storage unit of the user terminal and determines that the user utterance matches the registered user utterance.

(11) The information processing device according to (9) or (10), in which

the data processing unit

transmits an inquiry for confirming an intention of the user to execute the settlement processing to the user terminal

in a case where an authentication error notification is received from the user terminal.

(12) The information processing device according to (11), in which

the data processing unit

executes the settlement processing in a case where a notification indicating that the user has the intention to execute the settlement processing is received from the user terminal.

(13) The information processing device according to any one of (9) to (12), in which

the data processing unit

transmits a user image captured with a camera to the user terminal via the communication unit, and

executes the settlement processing in response to a payment execution notification received from the user terminal when authentication based on the user image is established in the user terminal.

(14) A settlement processing system including: a user terminal; and a store terminal, in which

the store terminal

inputs a user utterance made by a user and designating a settlement means via a microphone, executes voice recognition processing to determine the settlement means designated by the user, and

transmits the user utterance to the user terminal via the communication unit,

the user terminal

determines whether or not the user utterance input from the store terminal matches a registered user utterance for collation stored in a storage unit, and

transmits a payment execution notification to the store terminal in response to determination that the user utterance matches the registered user utterance, and

the store terminal

executes settlement processing in response to the payment execution notification received from the user terminal.

(15) The settlement processing system according to (14), in which

the user terminal

transmits an authentication error notification to the store terminal in a case where it is not determined that the user utterance input from the store terminal matches the registered user utterance for collation stored in the storage unit, and

the store terminal

transmits an inquiry for confirming an intention of the user to execute the settlement processing to the user terminal

in a case where the authentication error notification is received from the user terminal.

(16) The settlement processing system according to (15), in which

the store terminal

executes the settlement processing in a case where a notification indicating that the user has the intention to execute the settlement processing is received from the user terminal.

(17) An information processing method executed by a data processing unit of an information processing device, the information processing method including:

inputting a user utterance made by a user and designating a settlement means from a store terminal via the communication unit;

determining whether or not the user utterance input from the store terminal matches a registered user utterance for collation stored in a storage unit; and

communicating with the store terminal to perform settlement processing in response to determination that the user utterance matches the registered user utterance.

(18) An information processing method executed by a data processing unit of an information processing device, the information processing method including:

inputting a user utterance made by a user and designating a settlement means via a microphone, executing voice recognition processing to determine the settlement means designated by the user;

transmitting the user utterance to the user terminal via a communication unit; and

executing settlement processing in response to a payment execution notification received from the user terminal when authentication based on the user utterance is established in the user terminal.

(19) A program for causing a data processing unit of an information processing device to execute information processing including:

inputting a user utterance made by a user and designating a settlement means from a store terminal via the communication unit;

determining whether or not the user utterance input from the store terminal matches a registered user utterance for collation stored in a storage unit; and

communicating with the store terminal to perform settlement processing in response to determination that the user utterance matches the registered user utterance.

(20) A program for causing a data processing unit of an information processing device to execute information processing including:

inputting a user utterance made by a user and designating a settlement means via a microphone, executing voice recognition processing to determine the settlement means designated by the user;

transmitting the user utterance to the user terminal via a communication unit; and

executing settlement processing in response to a payment execution notification received from the user terminal when authentication based on the user utterance is established in the user terminal.

Furthermore, the series of processing described in the specification can be executed by hardware, software, or a configuration in which both are combined. In the case of executing processing by software, a program recording a processing sequence can be installed in a memory in a computer incorporated in dedicated hardware and executed, or the program can be installed in a general-purpose computer capable of executing various types of processing and executed. For example, the program can be recorded in advance in a recording medium. In addition to installation from a recording medium to a computer, the program can be received via a network such as a local area network (LAN) or the Internet and installed in a recording medium such as a built-in hard disk.

Note that various types of processing described in the specification may be executed not only in time series according to the description but also in parallel or individually according to a processing capability of a device that executes the processing or as necessary. Furthermore, in the present specification, a system is a logically assembled configuration of a plurality of devices, and is not limited to a system in which devices having respective configurations are in the same housing.

### INDUSTRIAL APPLICABILITY

As described above, according to a configuration of an embodiment of the present disclosure, a configuration is implemented in which a settlement means designated by a user who makes settlement is confirmed, and the settlement involving communication with a user terminal of the user is reliably made.

Specifically, for example, a store terminal inputs, via a microphone, a user utterance made by the user and designating the settlement means, executes voice recognition processing to determine the settlement means designated by the user, and transmits the user utterance to the user terminal via a communication unit. The user terminal determines whether or not the user utterance input from the store terminal matches a registered user utterance for collation stored in a storage unit, and transmits a payment execution notification to the store terminal on the basis of determination that the user utterance matches the registered user utterance. The store terminal executes the settlement processing in response to the payment execution notification received from the user terminal.

With this configuration, a configuration is implemented in which a settlement means designated by a user who makes settlement is confirmed, and the settlement involving communication with a user terminal of the user is reliably made.

### REFERENCE SIGNS LIST

10 Store terminal
20 User
21 User terminal
30 Store clerk
100 User terminal
101 Control unit (data processing unit)
102 Operation unit
103 Display unit
104 Secure element
105 Storage unit (memory)
106 Clock
110 First communication unit
111 Wi-Fi communication unit
112 Another communication unit
120 Second communication unit
121 NFC-CLF
122 Bluetooth (registered trademark) communication unit
123 Another communication unit
200 Store terminal
201 Microphone
202 Camera
220 Payer entry area identification mark
250 Store terminal main body
251 Control unit (data processing unit)
252 Communication unit
253 Short-range wireless communication unit
254 Input unit (microphone, camera, operation unit, and the like)
255 Output unit
256 Storage unit (memory)
301 CPU
302 ROM
303 RAM
304 Bus
305 Input/output interface
306 Input unit
307 Output unit
308 Storage unit
309 Communication unit
310 Drive
311 Removable medium

1. An information processing device comprising:
a communication unit; and
a data processing unit, wherein
the data processing unit
inputs a user utterance made by a user and designating a settlement means from a store terminal via the communication unit,
determines whether or not the user utterance input from the store terminal matches a registered user utterance for collation stored in a storage unit, and
communicates with the store terminal to perform settlement processing in response to determination that the user utterance matches the registered user utterance.

2. The information processing device according to claim 1, wherein the storage unit stores one or more user utterances each designating a settlement means as user utterances for collation.

3. The information processing device according to claim 1, wherein
the data processing unit
transmits information necessary for the settlement processing to the store terminal
in a case where it is determined that the user utterance input from the store terminal matches the registered user utterance for collation stored in the storage unit.

4. The information processing device according to claim 1, wherein
the data processing unit
sends an error notification to the store terminal
in a case where it is not determined that the user utterance input from the store terminal matches the registered user utterance for collation stored in the storage unit.

5. The information processing device according to claim 1, wherein
the data processing unit
displays user intention confirmation data on a display unit in a case where an inquiry for confirming an intention of the user to execute the settlement processing is received from the store terminal, and
transmits a notification indicating that the user has the intention to execute the settlement processing to the store terminal in a case where the user makes an input indicating the intention to execute the settlement processing.

6. The information processing device according to claim 1, wherein
the data processing unit
inputs the user utterance made by the user and designating the settlement means via a microphone,
determines whether or not the user utterance input via the microphone matches the registered user utterance for collation stored in the storage unit, and
communicates with the store terminal to perform the settlement processing in response to determination that the user utterance matches the registered user utterance.

7. The information processing device according to claim 1, wherein
the data processing unit
inputs information regarding a settlement means selected by the user from a plurality of settlement means displayed on a display unit,
selects a user utterance designating the settlement means selected by the user from registered user utterances stored in the storage unit, and transmits the selected user utterance to the store terminal.

8. The information processing device according to claim 1, wherein
the data processing unit
inputs, from the store terminal that captures a user image with a camera, the user image via the communication unit,
determines whether or not a person of the user image input from the store terminal matches a person of a registered user image for collation stored in the storage unit, and
communicates with the store terminal to perform the settlement processing in response to determination that the person of the user image matches the person of the registered user image.

9. An information processing device comprising:
a microphone;
a communication unit that communicates with a user terminal; and
a data processing unit, wherein
the data processing unit
inputs a user utterance made by a user and designating a settlement means via the microphone, executes voice recognition processing to determine the settlement means designated by the user,
transmits the user utterance to the user terminal via the communication unit, and
executes settlement processing in response to a payment execution notification received from the user terminal when authentication based on the user utterance is established in the user terminal.

10. The information processing device according to claim 9, wherein
the payment execution notification from the user terminal
is a notification transmitted to the information processing device in a case where the user terminal determines whether or not the user utterance received from the information processing device matches a registered user utterance preregistered in a storage unit of the user terminal and determines that the user utterance matches the registered user utterance.

11. The information processing device according to claim 9, wherein
the data processing unit
transmits an inquiry for confirming an intention of the user to execute the settlement processing to the user terminal
in a case where an authentication error notification is received from the user terminal.

12. The information processing device according to claim 11, wherein
the data processing unit
executes the settlement processing in a case where a notification indicating that the user has the intention to execute the settlement processing is received from the user terminal.

13. The information processing device according to claim 9, wherein
the data processing unit
transmits a user image captured with a camera to the user terminal via the communication unit, and
executes the settlement processing in response to a payment execution notification received from the user terminal when authentication based on the user image is established in the user terminal.

14. A settlement processing system comprising: a user terminal; and a store terminal, wherein
the store terminal
inputs a user utterance made by a user and designating a settlement means via a microphone, executes voice recognition processing to determine the settlement means designated by the user, and
transmits the user utterance to the user terminal via the communication unit,
the user terminal
determines whether or not the user utterance input from the store terminal matches a registered user utterance for collation stored in a storage unit, and
transmits a payment execution notification to the store terminal in response to determination that the user utterance matches the registered user utterance, and
the store terminal
executes settlement processing in response to the payment execution notification received from the user terminal.

15. The settlement processing system according to claim 14, wherein
the user terminal
transmits an authentication error notification to the store terminal in a case where it is not determined that the user utterance input from the store terminal matches the registered user utterance for collation stored in the storage unit, and
the store terminal
transmits an inquiry for confirming an intention of the user to execute the settlement processing to the user terminal
in a case where the authentication error notification is received from the user terminal.

16. The settlement processing system according to claim 15, wherein
the store terminal
executes the settlement processing in a case where a notification indicating that the user has the intention to execute the settlement processing is received from the user terminal.

17. An information processing method executed by a data processing unit of an information processing device, the information processing method comprising:
inputting a user utterance made by a user and designating a settlement means from a store terminal via the communication unit;
determining whether or not the user utterance input from the store terminal matches a registered user utterance for collation stored in a storage unit; and
communicating with the store terminal to perform settlement processing in response to determination that the user utterance matches the registered user utterance.

18. An information processing method executed by a data processing unit of an information processing device, the information processing method comprising:
inputting a user utterance made by a user and designating a settlement means via a microphone, executing voice recognition processing to determine the settlement means designated by the user;
transmitting the user utterance to the user terminal via a communication unit; and
executing settlement processing in response to a payment execution notification received from the user terminal when authentication based on the user utterance is established in the user terminal.

19. A program for causing a data processing unit of an information processing device to execute information processing comprising:
inputting a user utterance made by a user and designating a settlement means from a store terminal via the communication unit;
determining whether or not the user utterance input from the store terminal matches a registered user utterance for collation stored in a storage unit; and
communicating with the store terminal to perform settlement processing in response to determination that the user utterance matches the registered user utterance.

20. A program for causing a data processing unit of an information processing device to execute information processing comprising:
inputting a user utterance made by a user and designating a settlement means via a microphone, executing voice recognition processing to determine the settlement means designated by the user;
transmitting the user utterance to the user terminal via a communication unit; and
executing settlement processing in response to a payment execution notification received from the user terminal when authentication based on the user utterance is established in the user terminal.
